(19) United States
(12) Patent Application Publication
(10) Pub. No.: US 2023/0367539 A1
(43) Pub. Date: Nov. 16, 2023

(54) GENERATING INTERACTIVE SESSION CAPTURES THAT CONTINUOUSLY HIGHLIGHT ACTIVE SPEAKERS DURING PLAYBACK

(71) Applicant: Meta Platforms, Inc., Menlo Park, CA (US)

(72) Inventors: Hemal Khatri, Redmond, WA (US); Joel Alexander Sharin, Seattle, WA (US); Pradeep George Mathias, Berkeley, CA (US); Adam Zerby, Seattle, WA (US); Deepan Gupta, Sunnyvale, CA (US); Ananth Balakrishna Vasishta, Seattle, WA (US); Suhel Reto Sheikh, Newark, CA (US); Jihoon Suh, Seattle, WA (US); Michael Sheppard Horowitz, New York, NY (US); Guy Shlomo Assedou, Van Nuys, CA (US); Biwei Ni, Jersey City, NJ (US); Dhigha Sekaran, Issaquah, WA (US); Vinay Mahagaokar, Sugar Land, TX (US); Yi Shen, Issaquah, WA (US); Mengwei Ding, Sunnyvale, CA (US); Nikhil Mahendra Shah, New York, NY (US); Mark Shwartzman, Campbell, CA (US); Ashish Gupta, Santa Clara, CA (US)

(21) Appl. No.: 17/573,519

(22) Filed: Jan. 11, 2022

(51) Int. Cl. G06F 3/16; H04L 65/65; G06F 3/0482; G06F 3/0484; G10L 15/26

(52) U.S. Cl. CPC G06F 3/165; H04L 65/608; G06F 3/0482; G06F 3/0484; G10L 15/26

(57) ABSTRACT

The disclosed computer-implemented method may include systems and methods for generating and providing interactive sessions and interactive session captures. For example, upon completion of an interactive session, systems and methods described herein can generate an interactive session playback interface associated with an interactive session capture that includes various interactive features. During playback of the interactive session capture, the systems and methods described herein can update features of the interactive session playback interface to mirror interactions that occurred in the original interactive session, as well as provide additional interactive features associated with the interactive session capture. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a network environment in which an interactive session system operates according to one or more embodiments.

FIGS. 2A-2D illustrate overview sequence diagrams of the interactive session system generating and providing various interactive session features to computing devices associated with users at different user levels or permission settings according to one or more embodiments.

FIGS. 3A-3AB illustrate example interfaces generated by the interactive session system prior to, during, and upon conclusion of an interactive session, as well as during playback of an interactive session capture according to one or more embodiments.

FIG. 4 illustrates a schematic diagram of the interactive session system according to one or more embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Multimedia systems may include many interactive features. For example, multimedia systems may generate multimedia sessions that include video and/or audio that can be accessed by multiple hosts, speakers, presenters, listeners, and/or watchers. Additionally, multimedia systems may generate and provide recordings of multimedia sessions such that listeners or watchers can listen to or view a multimedia session after it has concluded.

Unfortunately, many multimedia systems are technologically deficient in several regards. For instance, some multimedia systems generate rigid multimedia session recordings that are limited solely to playback of the audio and/or visual components of the multimedia sessions. In this regard, the multimedia session recordings generated by such multimedia systems present themselves as traditional audio recordings or videos.

Moreover, some multimedia systems are inaccurate. For instance, many multimedia sessions generated by multimedia systems include—or are associated with—other interactive features beyond an audio and/or visual presentation. To illustrate, a multimedia session including audio and visual components generated by an example multimedia system may also include a real-time chat feature where viewers can add digital messages to a chat thread. Multimedia session recordings generated by such multimedia systems, however, do not capture or reflect how these additional interactive features were utilized during the original multimedia session. Because of this, many multimedia systems generate computational waste in generating and providing additional functionality as a recording listener/watcher attempts to determine who participated in the original multimedia session, whether any social networking system connections exist among those participants, and so forth.

The present disclosure, in contrast, is generally directed to systems and methods for generating and providing interactive session captures of interactive sessions that include audio and visual components as well as other interactive functionality. As will be explained in greater detail below, embodiments of the present disclosure may generate and provide an interactive session capture of an interactive session. In response to a detected selection of a display option associated with the interactive session capture, the systems and methods disclosed herein can generate and provide an interactive session playback interface for playback of the interactive session capture that includes display elements associated with the participants (e.g., speakers and audience members) of the now-concluded interactive session, as well as other social networking system information and interactivity associated with the now-concluded interactive session.

During playback of the interactive session capture, the systems and methods disclosed herein may continuously update these display elements to indicate a current active speaker of the interactive session capture as well as other social networking system activity that occurred at various points during the original interactive session. In some embodiments, the systems and methods disclosed herein provide additional interactive functionality associated with an interactive session capture such that social networking activity can continue to occur in connection with the interactive session even though the interactive session has concluded.

As discussed above, many multimedia systems suffer from various technical problems related to the functionality of a computing system. In one or more embodiments, the systems and methods described herein solve these and other technical issues by flexibly, accurately, and efficiently generating interactive session captures that encapsulate the audio and visual components of an interactive session in addition to other interactive functionality associated with the interactive session.

For example, the systems and methods disclosed herein may generate interactive session captures that are not limited to just the audio and visual components of an interactive session. Instead, the systems and methods disclosed herein may generate flexible interactive session captures that encapsulate all of the features and interactivity of interactive sessions. For instance, a generated interactive session capture can include visual and audio components of an interactive session, in addition to social networking system activity that occurred during the interactive session, comments that were made by interactive session participants during the interactive session, reactions that were indicated by interactive session participants during the interactive session, rosters of hosts and speakers associated with the interactive session, a constantly updating highlight element indicating current speakers in the interactive session, as well as other interactive features. Furthermore, these systems and methods may enable additional social networking system activity to occur relative to a concluded interactive session during playback of the interactive session capture of that interactive session.

Accordingly, the systems and methods disclosed herein may improve the accuracy of computing systems. For instance, because the disclosed systems and methods encapsulate all of the interactive activity associated with and surrounding an interactive session in an interactive session capture, the generated interactive session capture may present a complete and accurate picture of the interactive session. As such, the systems and methods disclosed herein may further improve computational efficiency by avoiding the computational waste typically associated with determining other types of interactive activity that occurred during the interactive session.

Features from any of the embodiments described herein may be used in combination with one another in accordance with the general principles described herein. These and other embodiments, features, and advantages will be more fully understood upon reading the following detailed description in conjunction with the accompanying drawings and claims.

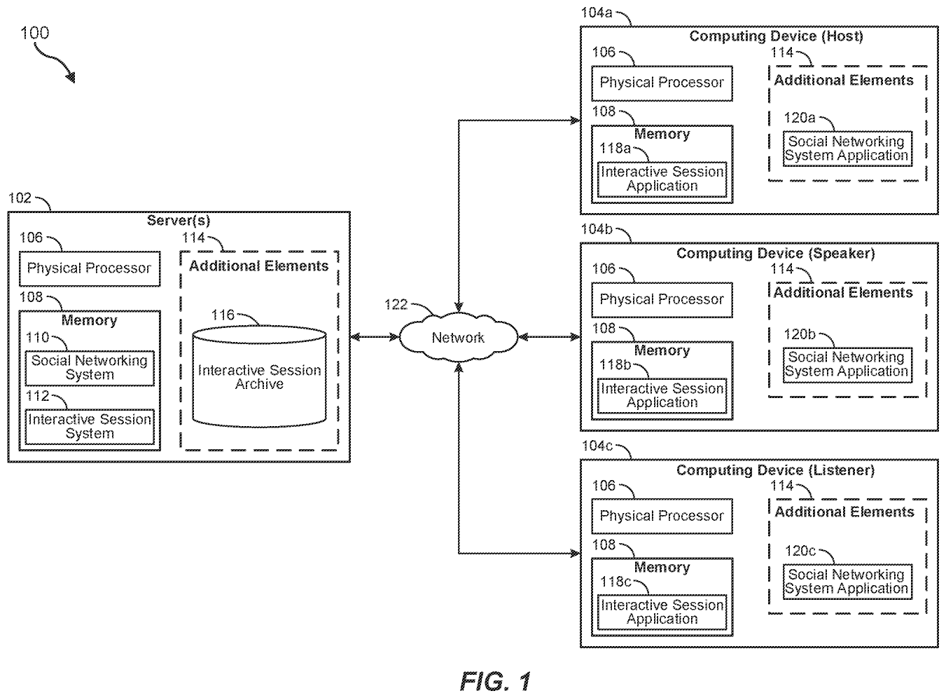

The following will provide, with reference to FIGS. 1-4, detailed descriptions of an interactive session system generating and providing accurate and flexible interactive session captures of interactive sessions for later playback. For example, FIG. 1 illustrates an exemplary network environment 100 implementing aspects of the present disclosure. For example, the network environment 100 can include server(s) 102, a computing device 104a, a computing device 104b, a computing device 104c, and a network 122. As mentioned above, in one or more embodiments, an interactive session system 112 can be implemented by the server(s) 102 including a physical processor 106, a memory 108, and additional elements 114. Similarly, the computing devices 104a-104c may also include physical processors 106, memories 108, and additional elements 114.

Additionally, in one or more embodiments, the computing devices 104a-104c can also include an interactive session application 118a, 118b, and 118c, respectively. In one or more embodiments, users of the computing device 104a-104c can interact with the interactive session system 112 via the interactive session applications 118a-118c in different ways. For example, the user of the computing device 104a (e.g., an interactive session host) can interact with the interactive session system 112 via the interactive session application 118a to schedule an interactive session, invite broadcasters (e.g., speakers) and audience members to attend the interactive session, configure an interactive session, initiate an interactive session, participate in an interactive session, and so forth.

Additionally, a user of the computing device 104b (e.g., an interactive session broadcaster or speaker) can interact with the interactive session system 112 via the interactive session application 118b to accept an invitation to speak in a scheduled interactive session, join an interactive session, participate in an interactive session, and so forth. Furthermore, the user of the computing device 104c (e.g., an interactive session listener or audience member) can interact with the interact with the interactive session system 112 via the interactive session application 118c to indicate interest in a scheduled interactive session, join an interactive session, view and/or listen to an interactive session, and access interactive session captures of concluded interactive sessions. In at least one embodiment, the interactive session applications 118a-118c include all or any combination of the features utilized by the users of the computing devices 104a-104c (e.g., hosts, broadcasters, and audience members).

In one or more embodiments, the interactive session system 112 operates in concert with a social networking system 110. For example, in at least one embodiment, the interactive session system 112 provides tools and options for scheduling, initiating, distributing, participating in, and capturing an interactive session via the social networking system 110. To illustrate, the social networking system 110 can generate and provide customized newsfeeds of posts and other digital content to the computing devices 104a-104c via the social networking system applications 120a, 120b, and 120c, respectively. The interactive session system 112 can also provide configuration tools to schedule and configure a future interactive session via any of the social networking system application 120a-120c. Similarly, the interactive session system 112 can provide an access gateway to participate in, view, and/or listen to an interactive session via any of the social networking system applications 120a-120c. Additionally, the interactive session system 112 can provide interactive session captures via any of the social networking system applications 120a-120c. Additionally or alternatively, the interactive session system 112 can provide this same functionality solely via the interactive session applications 118a-118c (i.e., the interactive session applications 118a-118c may be standalone applications).

As further shown in FIG. 1, the server(s) 102 may also include an interactive session archive 116. In one or more embodiments, and as will be discussed in greater detail below, the interactive session system 112 generates interactive session captures that embody all activity that occurred during original interactive sessions. In at least one embodiment, the interactive session system 112 can store these interactive session captures in the interactive session archive 116. For example, the interactive session system 112 can index or organize interactive session captures within the interactive session archive according to host, according to broadcaster, according to topic, according to date, and so forth. In at least one embodiment, the interactive session system 112 provides access to the interactive session archive via any of the social networking system applications 120a-120c and/or the interactive session applications 118-118c.

The computing devices 104a-104c may be communicatively coupled to the server(s) 102 through the network 122. The network 122 may represent any type or form of communication network, such as the Internet, and may comprise one or more physical connections, such as a LAN, and/or wireless connections, such as a WAN.

Although FIG. 1 illustrates components of the network environment 100 in one arrangement, other arrangements are possible. For example, in one embodiment, the interactive session system 112 and/or social networking system 110 may exist across multiple networked servers. In additional embodiments, the network environment 100 can include any number of computing devices such that there are multiple hosts, broadcasters or speakers, and/or listeners (audience members).

As shown throughout, discussion of the features and functionalities of the interactive session system 112 references multiple terms. More detail regarding these terms is now provided. For example, as used herein, the term “interactive session” can refer to a digital multimedia event. In one or more embodiments, an interactive session can be supported by a social networking system (e.g., the social networking system 110) such that interactive session participants may access an interactive session via one or more social networking system gateways. Interactive sessions can be scheduled in advance or can be initiated on-the-fly. Additionally, in some embodiments, the interactive session system 112 can provide an interactive session to any number of participants (e.g., hosts, broadcasters, audience members).

In one or more embodiments, an interactive session can include multiple elements. For example, an interactive session can be displayed via an “interactive session interface” such as a graphical user interface that includes sounds, images, and interactive features. More particularly, the interactive session system 112 can generate an interactive session interface by which a participant can listen to an audio stream while viewing information (e.g., thumbnails, social networking system responses elements, comments, etc.) associated with the other participants in the interactive session.

In one or more embodiments, the interactive session system 112 can generate a transcription of the audio stream of an interactive session. As used herein, a “transcription” may refer to a textual translation of spoken words within an audio stream of an interactive session. For example, the interactive session system 112 can utilize one or more algorithms, models, or neural networks to generate a transcription of an audio stream. In at least one embodiment, the interactive session system 112 can generate a transcription in real-time such that an interactive session participant can view a transcription of spoken words as the words are spoken (e.g., in response to a detected selection of a closed caption option associated with the interactive session).

In one or more embodiments, the interactive session system 112 can generate an interactive session including various social networking system features. For example, as used herein, the term “social networking system response elements” may refer to ephemeral and visual responses of participants to an interactive session. For instance, the interactive session system 112 can generate an interactive session interface including controls that enable a participant to indicate a “like,” a “heart,” a “thumbs up,” and so forth. The interactive session system 112 can display these social networking system response elements ephemerally within the interactive session interface (e.g., floating through a portion of the interface for a predetermined amount of time).

Additionally, as used herein, the term “social networking system controls” may refer to controls within an interactive session interface that are tied to other features of the social networking system 110. For example, in one embodiment, the interactive session system 112 can include a social networking system control next to a thumbnail of a broadcaster in an interactive session that indicates whether the viewer of that interactive session or interactive session capture is associated with the broadcaster within the social networking system 110. In one embodiment, if the viewer is not associated with the broadcaster within the social networking system 110, the interactive session system 112 can enable the viewer to “follow” the speaker within the social networking system 110 in response to a detected selection of the social networking system control.

As discussed throughout, the interactive session system 112 can generate captures of interactive sessions. As used herein, the term “interactive session capture” may refer to a digital presentation of all information and activity that is associated with or that took place during an already-concluded interactive session. For example, an interactive session capture can include a recording of the audio stream of the interactive session, as well as a visual display of thumbnails of participants in the interactive session, a playback timeline indicating a playback position within the capture, one or more social networking system response elements, and so forth.

In at least one embodiment, an interactive session capture can include multiple views associated with the already-concluded interactive session that can toggle back and forth. To illustrate, the interactive session system 112 can generate an interactive session capture including a comment view including a comment thread of comments entered by participants during the interactive session. The interactive session system 112 can also generate an interactive capture including a speaker view including thumbnails associated with all or some of the participants in the interactive session. In at least one embodiment, the interactive session system 112 can generate the speaker view including a “highlight element” that indicates an interactive session participant who is speaking in the current portion of the audio track (e.g., an active speaker). Moreover, the interactive session system 112 can generate an interactive session capture that includes links to website and/or other access points, as well as other media items shared by the host(s) and/or speaker(s) during the now-concluded interactive session.

In one or more embodiments, the interactive session system 112 provides playback of an interactive session capture via an “interactive session playback interface.” In at least one embodiment, an interactive session playback interface includes and/or displays the various views and elements of a selected interactive session capture.

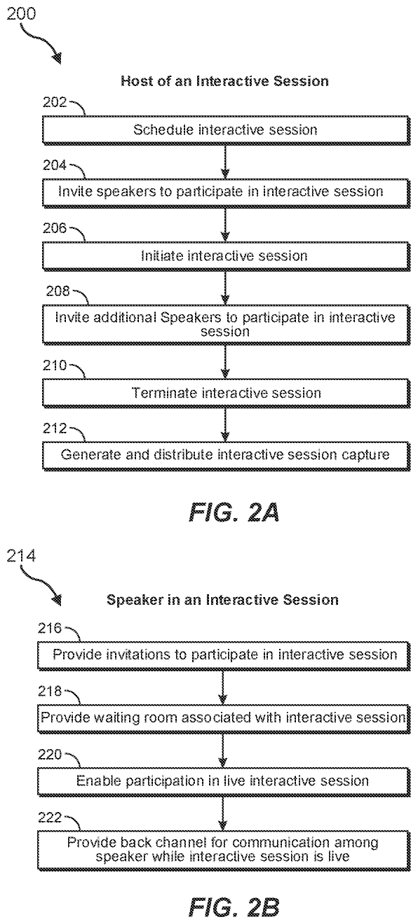

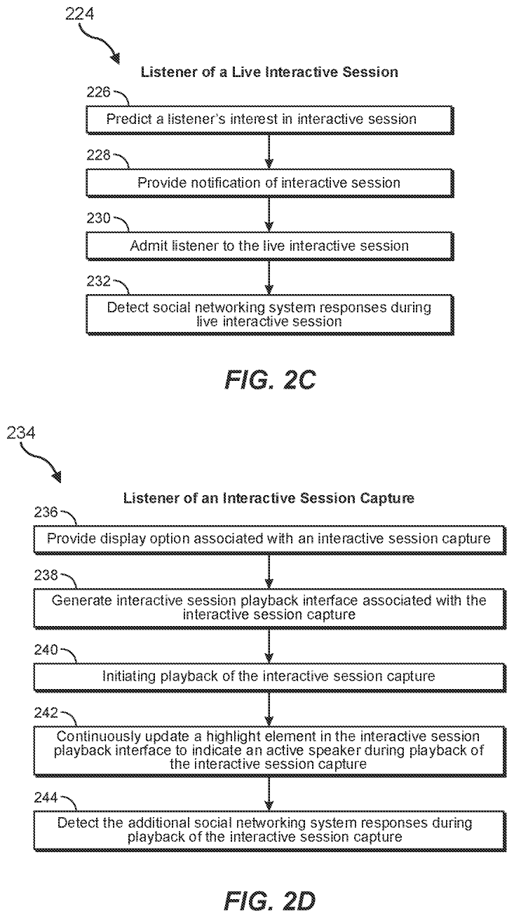

As discussed above, the interactive session system 112 generates, supports, and provides interactive sessions for different types of participants. FIGS. 2A, 2B, 2C, and 2D illustrate flow diagrams of exemplary computer-implemented methods including acts performed by the interactive session system 112 relative to different types of interactive session participants. For example, FIG. 2A illustrates a series of acts performed by the interactive session system 112 relative to an interactive session host (e.g., an interactive session system user who configures one or more features of an interactive session). FIG. 2B illustrates a series of acts performed by the interactive session system 112 relative to an interactive session speaker (e.g., a broadcaster who speaks during an interactive session). FIG. 2C illustrates a series of acts performed by the interactive session system 112 relative to a listener (e.g., an audience member) of a live interactive session, while FIG. 2D illustrates a series of acts performed by the interactive session system 112 relative to a listener of an interactive session capture.

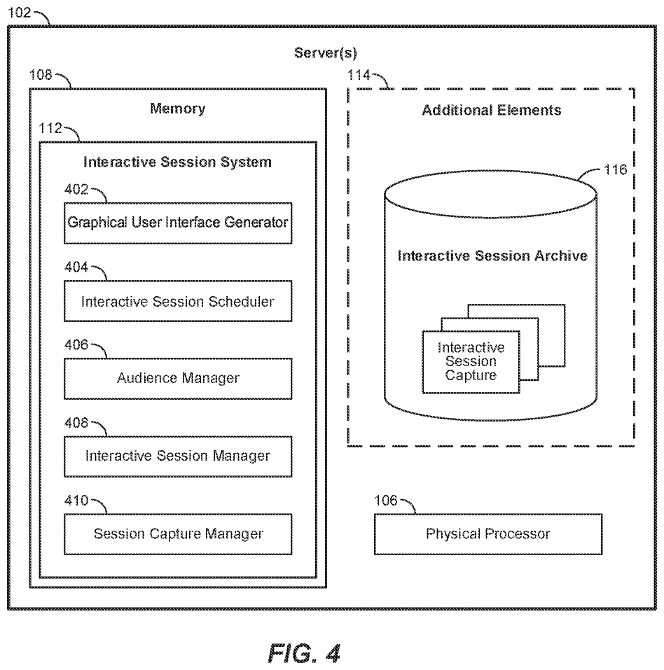

The steps shown in FIGS. 2A-2D may be performed by any suitable computer-executable code and/or computing system, including the system(s) illustrated in FIG. 4. In one example, each of the steps shown in FIGS. 2A-2D may represent an algorithm whose structure includes and/or is represented by multiple sub-steps, examples of which will be provided in greater detail below.

As shown in FIG. 2A, the interactive session system 112 can perform a computer-implemented method 200 including acts relative to a host of an interactive session. For example, the method 200 can include an act 202 of scheduling an interactive session. For example, the interactive session system 112 can provide tools and options for configuring and scheduling an interactive session via a social networking system application (e.g., the social networking system application 120a shown in FIG. 1), and/or via an interactive session application (e.g., the interactive session application 118a shown in FIG. 1). In response to detecting selections from a host computing device (e.g., the computing device 104a shown in FIG. 1), the interactive session system 112 can schedule an interactive session according to the detected configuration selections. For instance, the interactive session system 112 can schedule an interactive session according to configurations including, but not limited to, a selected date, a selected time, a selected topic, selected speakers, selected audience members, selected co-hosts, duration, capturing options, and so forth.

In one or more embodiments, the interactive session system 112 can further perform an act 204 of inviting speakers to participate in the scheduled interactive session. For example, based on the interactive session configurations received via the computing device 104a, the interactive session system 112 can generate and provide invitations to one or more selected co-hosts and/or speakers to participate in the scheduled interactive session. In at least one embodiment, the interactive session system 112 can generate and provide updates to the host regarding speakers and/or co-hosts who have accepted or rejected the generated invitations.

The interactive session system 112 can also perform an act 206 of initiating the scheduled interactive session. For example, the interactive session system 112 can initialize and/or instantiate an interactive session according to the date and time configured previously. Additionally, the interactive session system 112 can initialize the interactive session in response to a detected selection or command from the interactive session host (e.g., in response to a detected selection of a “go live” option or similar).

In one or more embodiments, the interactive session system 112 can perform an act 208 of inviting additional speakers to participate in the now-live interactive session. For example, in response to a detected selection from the interactive session host to invite one or more additional speakers to the initialized interactive session, the interactive session system 112 can generate and send an invitation to the one or more additional speakers to immediately join the live interactive session. In response to an additional speaker accepting the invitation, the interactive session system 112 can admit the additional speaker to the interactive session and/or upgrade permissions associated with the additional speaker if the additional speaker was an audience member of the interactive session.

The interactive session system 112 can further perform an act 210 of terminating the interactive session. For example, in one embodiment, the interactive session system 112 can terminate the interactive session in response to determining that the interactive session has been live for a pre-configured duration (e.g., thirty minutes, sixty minutes). In additional embodiments, the interactive session system 112 can terminate the interactive session in response to detecting a selection by the host or co-host of an option to terminate the interactive session (e.g., a selection of an “End” button or similar).

Furthermore, the interactive session system 112 can perform an act 212 of generating and distributing an interactive session capture. For example, the interactive session system 112 can generate a capture of the interactive session by compiling a recording of the audio stream of the interactive session with other features of the interactive session into a digital object or other storage element. To illustrate, the interactive session system 112 can compile the audio stream with features including, but not limited to, social networking system activity associated with the interactive session, a comment thread associated with the interactive session, speaker indexes relative to the interactive session, and information (e.g., social networking system information) associated with audience members and speakers who participated in the interactive session.

In at least one embodiment, the interactive session system 112 can distribute the generated interactive session capture in various ways. For example, and in response to a pre-configured distribution option, the interactive session system 112 can automatically distribute the interactive session capture to the audience members, speakers, and/or hosts who participated in the interactive session. Additionally, the interactive session system 112 can distribute the interactive session capture via the social networking system 110 by utilizing social networking system information to identify users who will likely be interested in the interactive session capture and providing the identified users with access to the interactive session capture via one or more social networking system gateways (e.g., an option presented via the identified users' newsfeeds).

As mentioned above, FIG. 2B illustrates a series of acts 214 performed by the interactive session system 112 relative to an interactive session speaker. As used herein, a speaker refers to an interactive session system user who accepts an invitation to speak or otherwise present in an interactive session configured by a host. In one or more embodiments, the interactive session system 112 can perform an act 216 of providing invitations to one or more proposed speakers to participate in an upcoming interactive session. For example, the interactive session system 112 can generate and provide a participation invitation to one or more speakers indicated by an interactive session host during configuration of the interactive session. In at least one embodiment, the interactive session system 112 can generate the participation invitations including the preconfigured date and time, as well as a preconfigured topic and/or topic description, as well as options to accept or reject the invitation. In response to a detected selection of the option to accept, the interactive session system 112 can add the speaker to a roster associated with the scheduled interactive session and can further provide the speaker with access to the interactive session once the interactive session is initiated. In one or more embodiments, the interactive session system 112 can add a speaker to the roster of speakers associated with a scheduled interactive session only in response to that speaker explicitly accepting the invitation to participate in the scheduled interactive session.

The interactive session system 112 can further perform an act 218 of providing a waiting room associated with the interactive session. For example, in one embodiment, the interactive session system 112 generates a “waiting room” associated with a scheduled interactive session. To illustrate, the interactive session system 112 offers the waiting room as a separate digital session where the host(s) of the interactive session can assemble with one or more speakers associated with the interactive session prior to the interactive session “going live” for audience members. In at least one embodiment, the interactive session system 112 treats a speaker entering the waiting room as a constructive acceptance by that speaker of the invitation to speak in the scheduled interactive session. The interactive session system 112 can generate the waiting room at any point prior to the scheduled interactive session and can admit any number of hosts and/or speakers into the waiting room. Additionally, the interactive session system 112 can generate the waiting room to include audio and visual capabilities such that hosts and/or speakers can speak in real-time, preview visual presentations, and so forth.

The interactive session system 112 can also perform an act 220 of enabling participation in a live interactive session. For example, in one embodiment, the interactive session system 112 can initiate the live interactive session in response to a detected selection of a “go live” option from within the waiting room (e.g., a selection made by a host and/or speaker). Additionally, the interactive session system 112 can initiate the live interactive session in response to determining that the current date and time correspond to a preconfigured date and time associated with the interactive session.

Following initiation of the interactive session, the interactive session system 112 enables speakers to participate in the interactive session in various ways. For example, the interactive session system 112 can follow a preconfigured agenda (e.g., submitted by the interactive session host) that includes an ordered listing of speakers and associated amounts of time. To illustrate, the interactive session system 112 can provide interactive session control to Speaker A for 10 minutes, then pass interactive session control to Speaker B for 10 minutes, etc. according to a preconfigured agenda. In at least one embodiment, the interactive session system 112 provides interactive session control to a particular speaker by muting all other speakers for the predetermined amount of time. Additionally or alternatively, the interactive session system 112 can enable microphone access to all of the hosts and speakers such that a less structured conversation can occur.

In some embodiments, the interactive session system 112 can generate the interactive session such that hosts and speakers are admitted into the interactive session with a different level of participation than audience members. For example, the interactive session system 112 can provide computing devices of hosts and speakers with both microphone and audio stream playback permissions such that those participants can both hear the interactive session and speak in the interactive session. The interactive session system 112 can simultaneously provide computing devices of audience members with only audio stream playback permissions. In that embodiment, the interactive session system 112 can enable speakers to speak within the interactive session in any order and/or combination for any amount of time.

In one or more embodiments, the interactive session system 112 further performs an act 222 of providing a back channel for communication among speakers while the interactive session is live. For example, the interactive session system 112 can generate a digital space similar to the waiting room after the interactive session has been initiated and provide access to this back channel to only the hosts and/or speakers. Hosts and/or speakers can utilize this digital space to discuss audience feedback and questions, preview responses, and generally communicate among themselves in a space that is inaccessible by the current interactive session audience. In at least one embodiment, the interactive session system 112 generates the back channel such that hosts and/or speakers can toggle back-and-forth between the back channel and the live interactive session at any point during the interactive session.

As mentioned above, FIG. 2C illustrates a series of acts 224 performed by the interactive session system 112 relative to a listener of a live interactive session. As used herein, a “live interactive session listener” may refer to an interactive session system user who joins a scheduled, live, or initiated interactive session. In some embodiments, the interactive session system 112 restricts or limits interactive session privileges for an interactive session listener. For example, the interactive session system 112 can limit an interactive session listener's access such that the listener can hear the audio stream of the interactive session and interact with various elements and features of the interactive session (e.g., the comment thread, social networking system response elements, etc.), but cannot speak or otherwise present during the live interactive session.

As shown in FIG. 2C, prior to the interactive session going live, the interactive session system 112 can perform an act 226 of predicting a listener's interest in an upcoming interactive session. For example, in one embodiment, the interactive session system 112 leverages the social networking system 110 to analyze social networking system activity information associated with a potential listener to identify the potential listener's interests.

To illustrate, the interactive session system 112 can analyze the social networking system activity information to identify the potential listener's posts, comments, groups, uploaded digital media, marketplace items, friends, likes, and so forth. From this analysis, the interactive session system 112 can predict that the potential listener is interested in one or more topics, ideas, events, etc. In at least one embodiment, the interactive session system 112 can compare these predicted interests to preconfigured topics associated with upcoming interactive session that are scheduled to occur within a threshold period of time (e.g., over the next week, over the next month). In additional embodiments, the interactive session system 112 can predict that a potential listener will be interested in an interactive session in response to determining that there is a social connection between the potential listener and the interactive session host or speaker within the social networking system 110 (e.g., the listener “follows” the host, the listener is “friends” with the speaker).

In response to predicting that a potential listener will be interested in an interactive session, the interactive session system 112 can perform an act 228 of providing notification of the interactive session in various ways. In one embodiment, and prior to the interactive session going live, the interactive session system 112 can generate and provide a notification associated with the interactive session to the listener's social networking system newsfeed. For example, the interactive session system 112 can generate the notification including information detailing the date and time of the interactive session, the host(s) and/or speakers associated with the interactive session, the topic of the interactive session, an option to R.S.V.P for the interactive session, an option to add the interactive session information to a calendar, and so forth. In one or more embodiments, the interactive session system 112 can cause the social networking system 110 to present the notification via the listener's newsfeed as a post, as an element within a tray or horizontal scroll, etc.

In additional embodiments, the interactive session system 112 can generate and provide a notification associated with the interactive session to the listener by way of a pop-up notification, a banner notification, an SMS text message, an email, or other digital communication. For example, the interactive session system 112 can generate any of these types of notifications including some or all of the information discussed above. Additionally, the interactive session system 112 can provide any of these notifications to the listener via the social networking system application 120c installed on the computing device 104c, via the interactive session application 118c, or via another native application installed on the computing device 104c (e.g., a text messaging application, an email application).

In other additional embodiments, the interactive session system 112 can generate and provide any of these types of notifications to the listener in response to determining that the interactive session has been initiated. For example, the interactive session system 112 can generate any of these types of notifications further including a “join now” option. The interactive session system 112 can provide a notification to the listener prior to the interactive session going live and can provide a second notification to the listener in response to the interactive session going live.

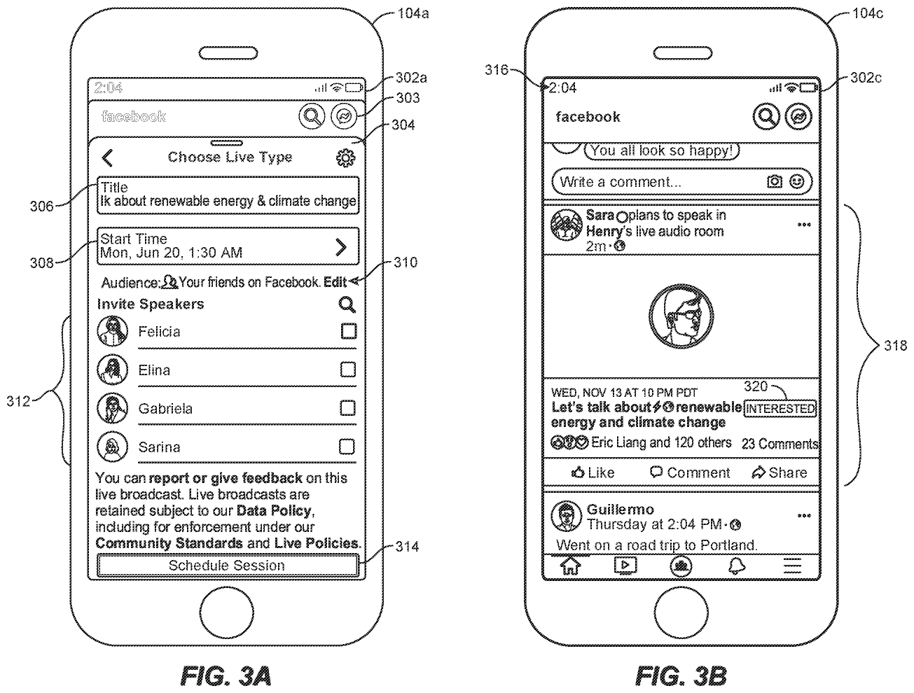

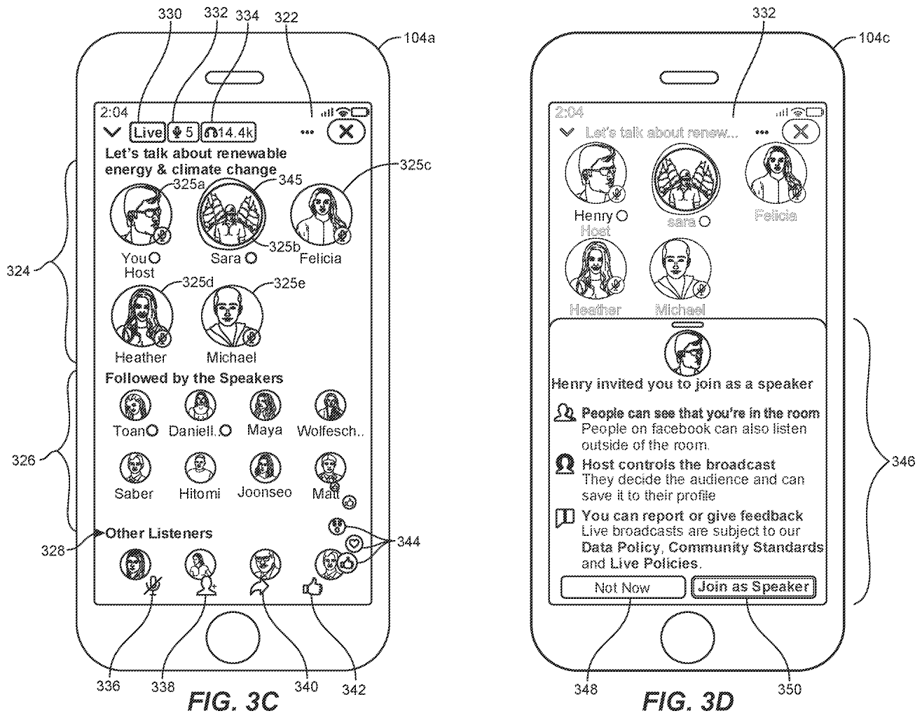

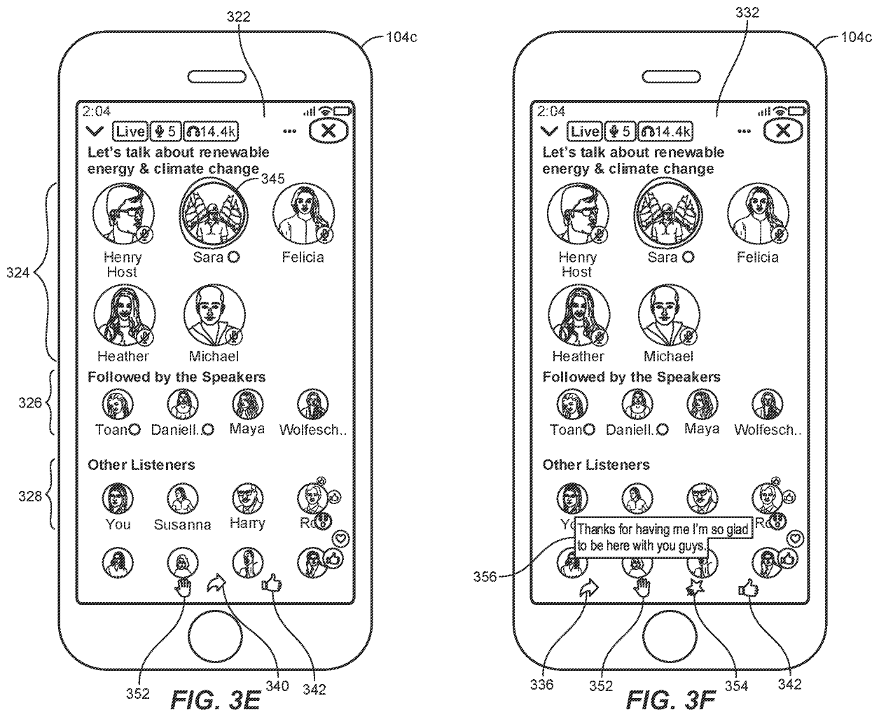

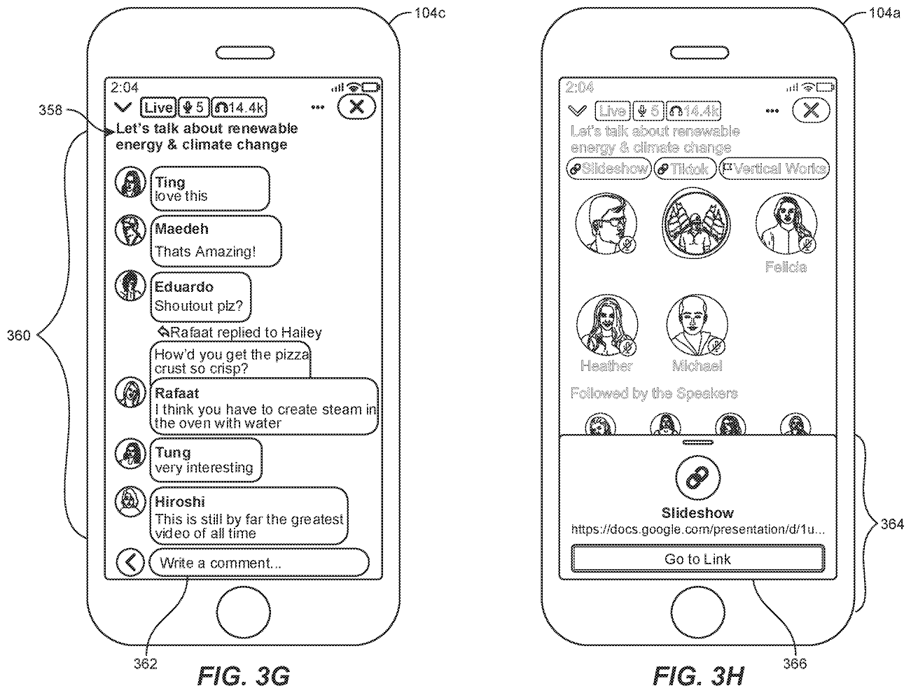

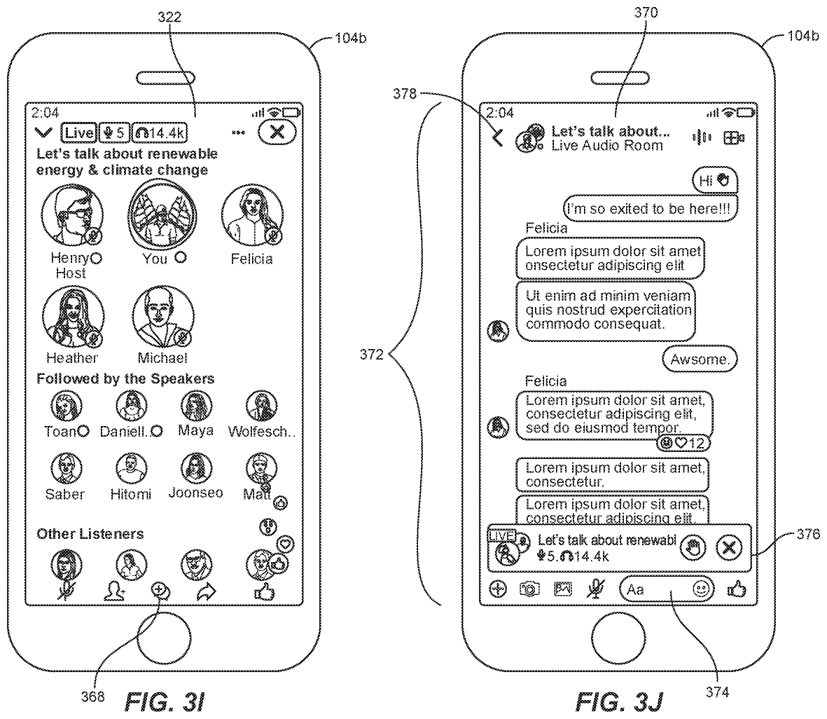

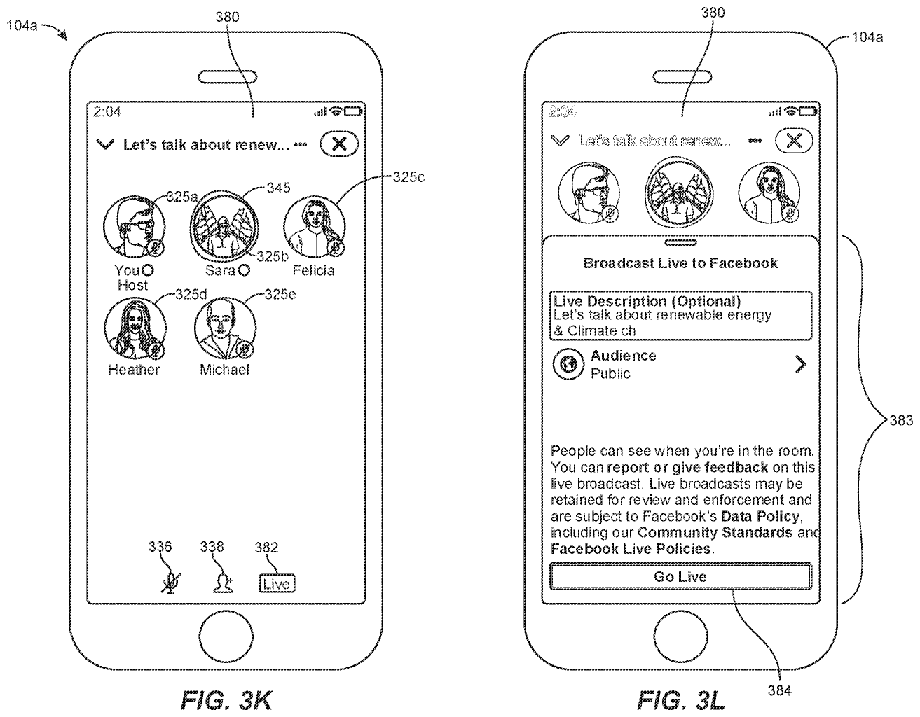

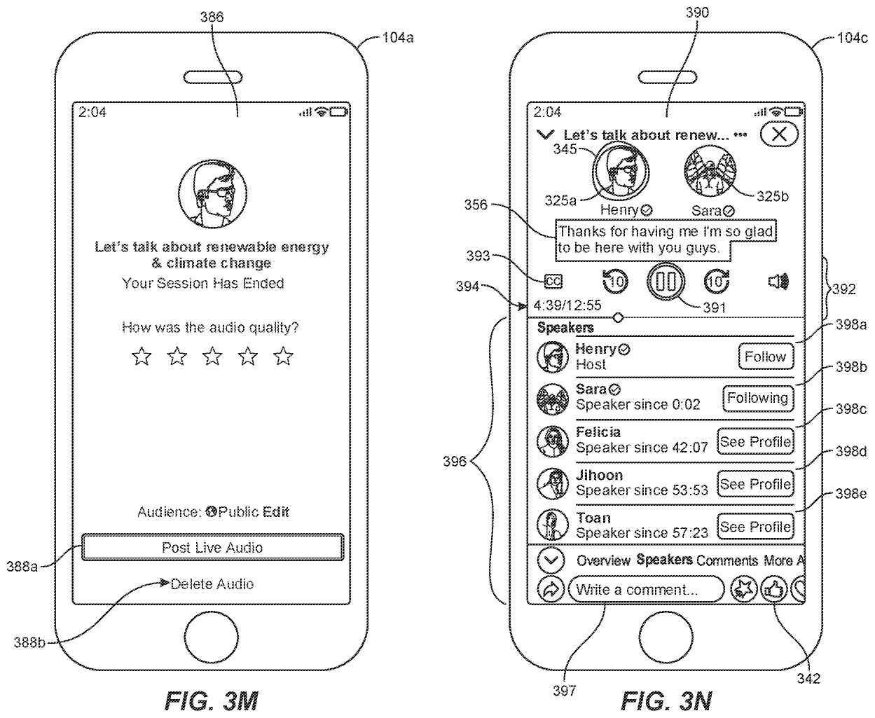

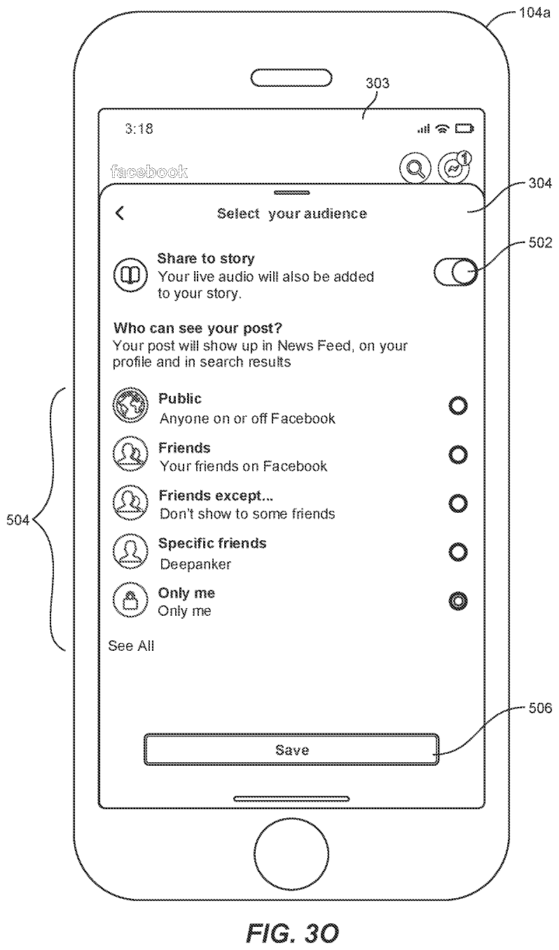

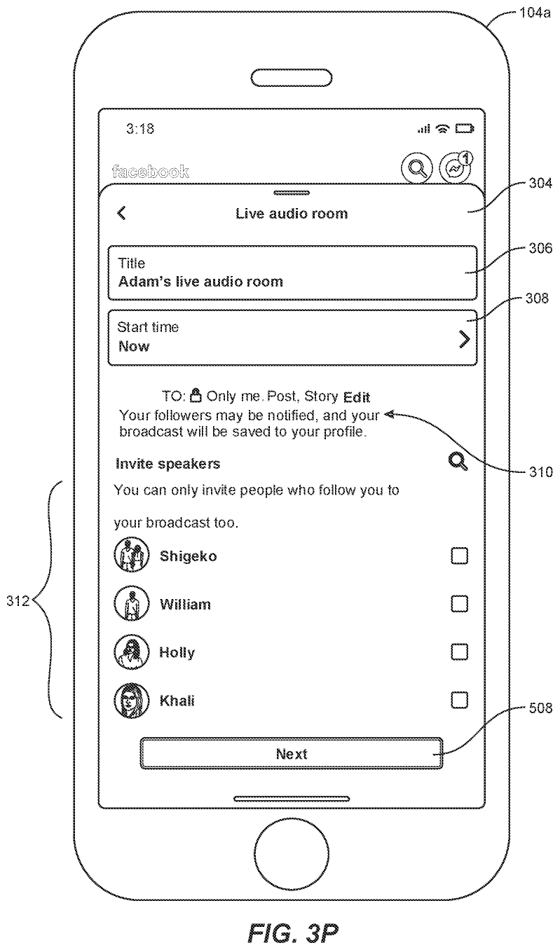

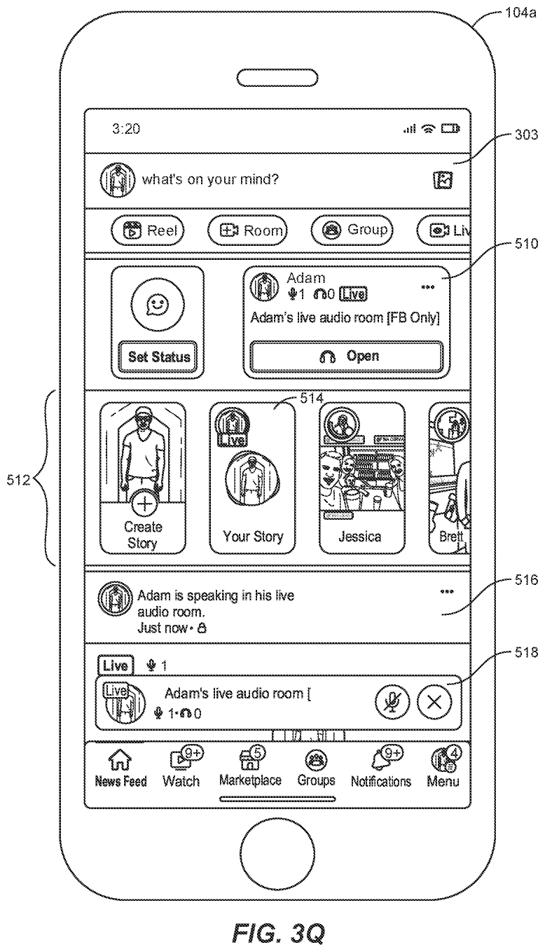

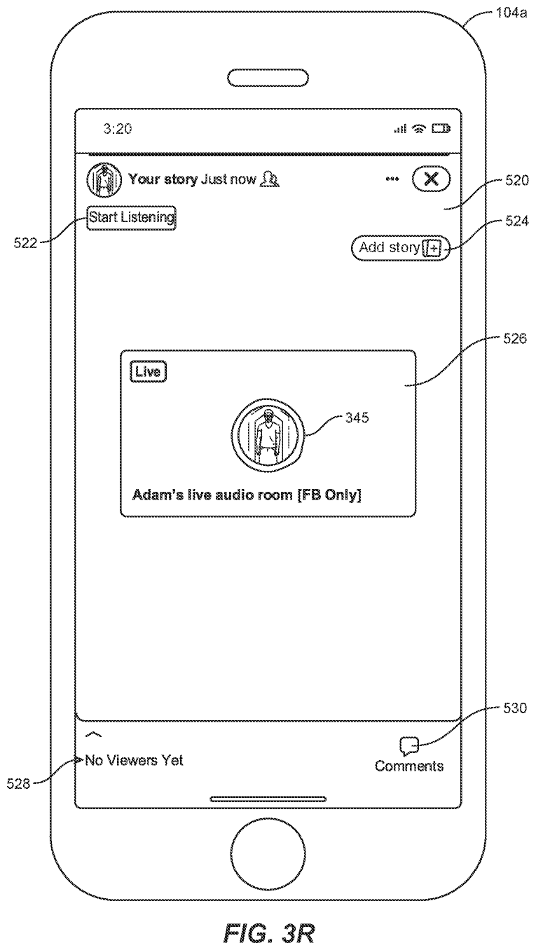

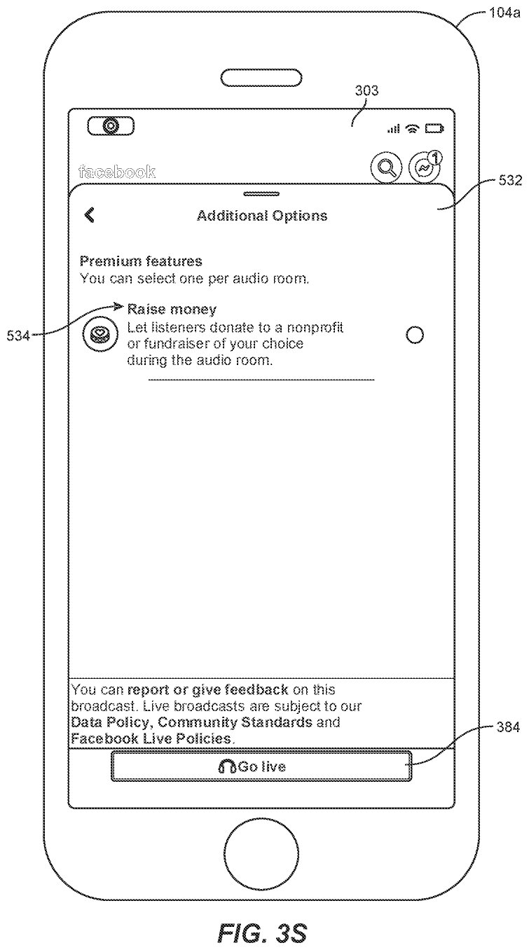

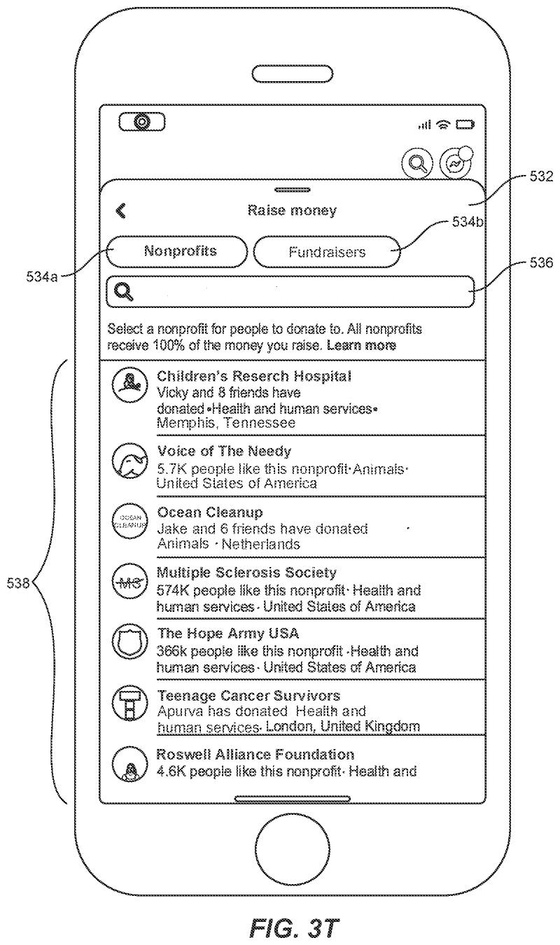

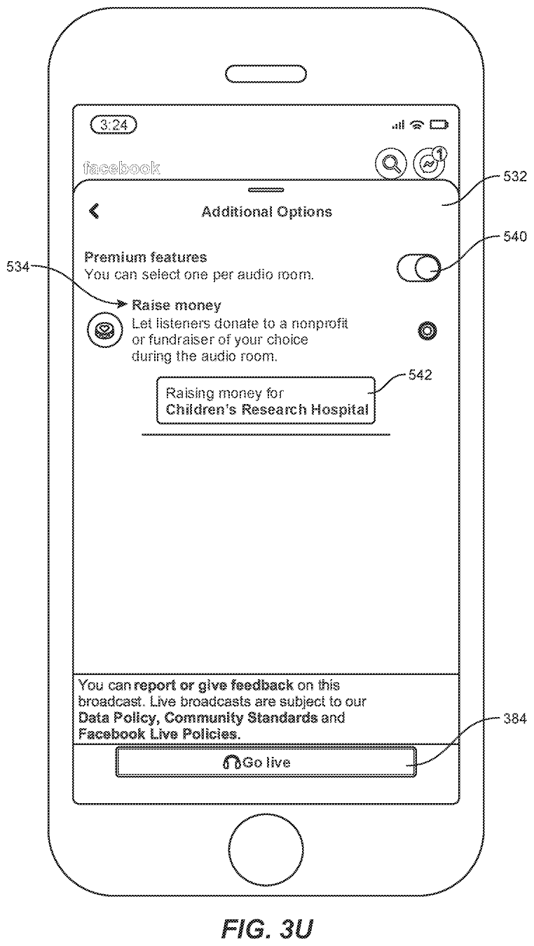

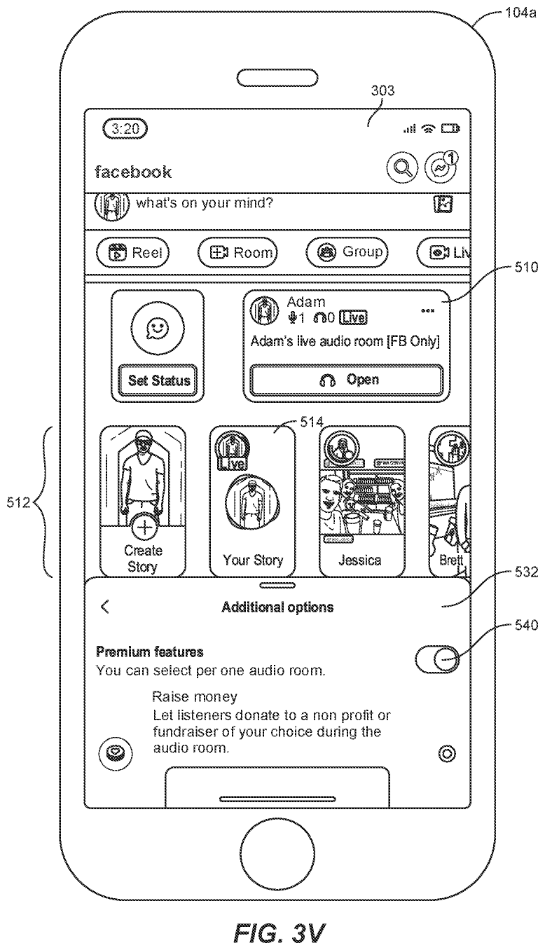

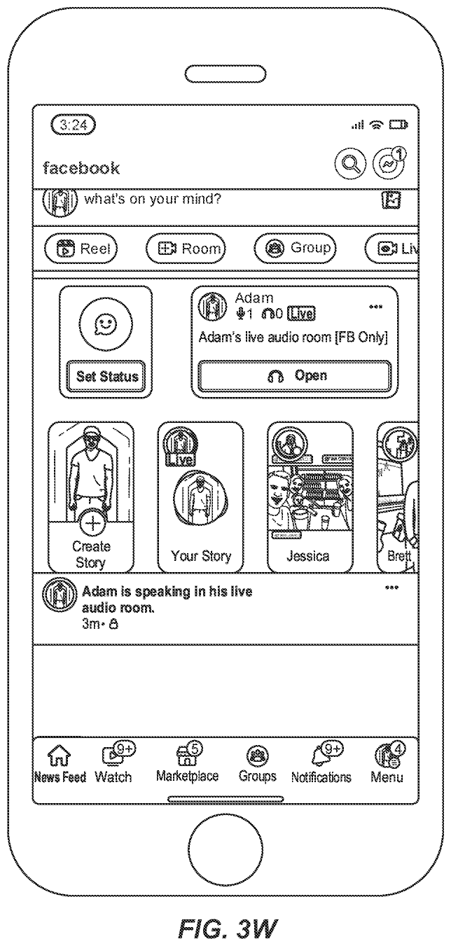

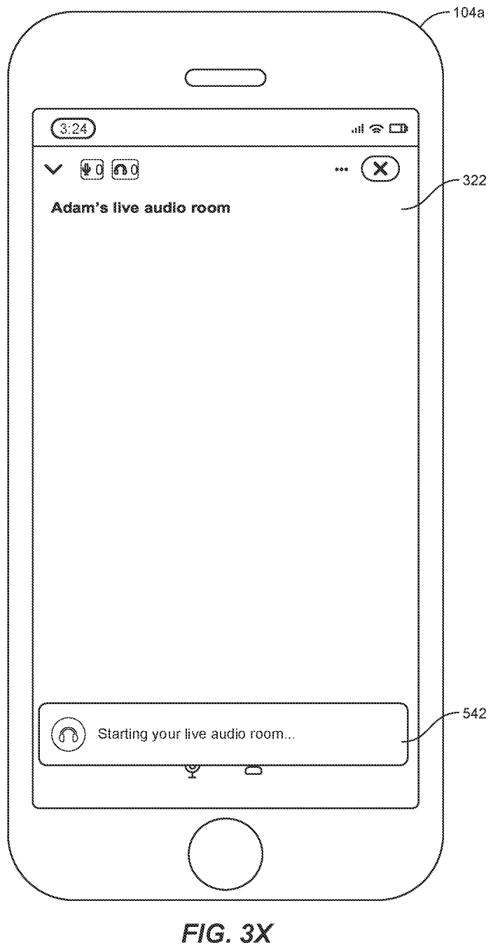

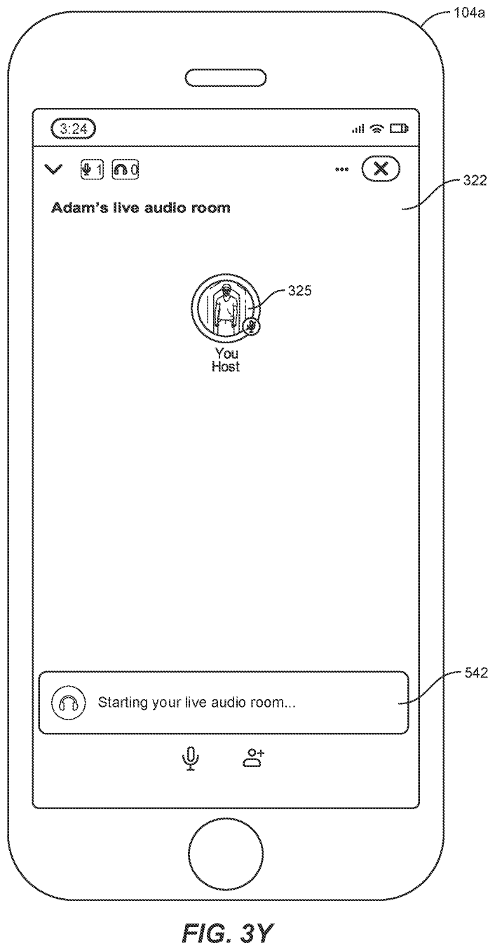

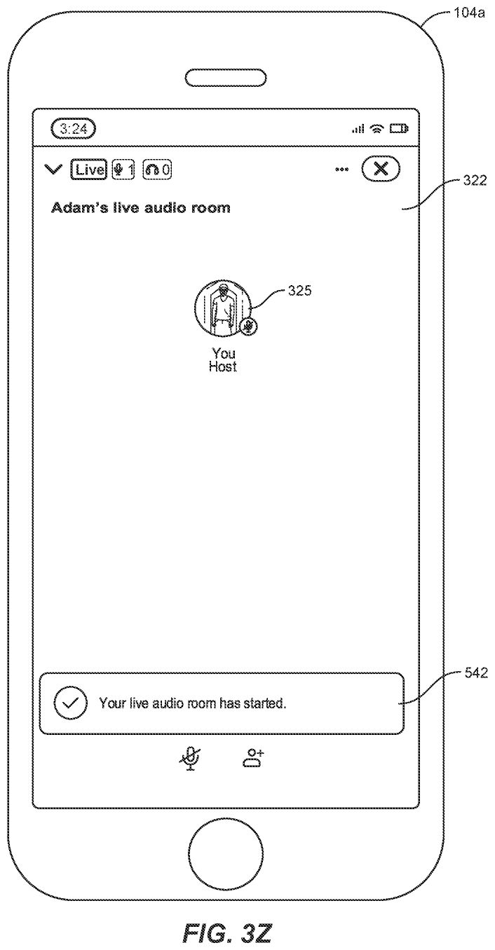

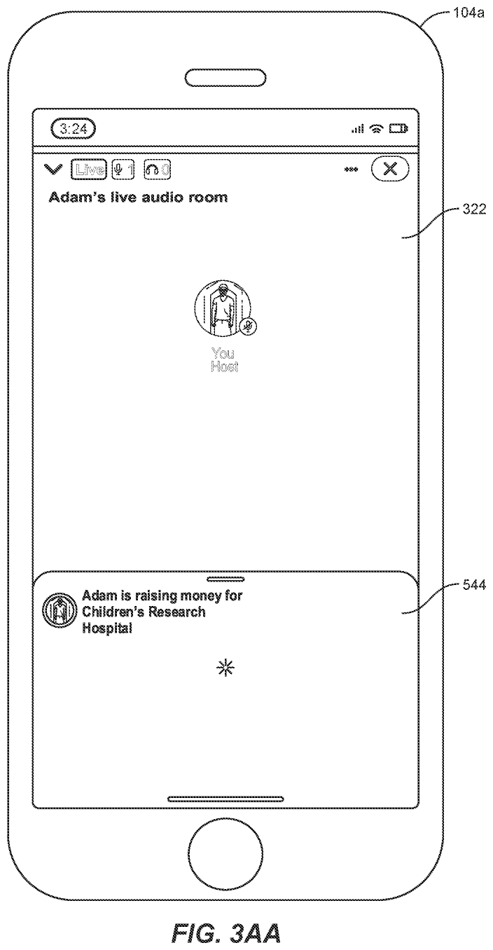

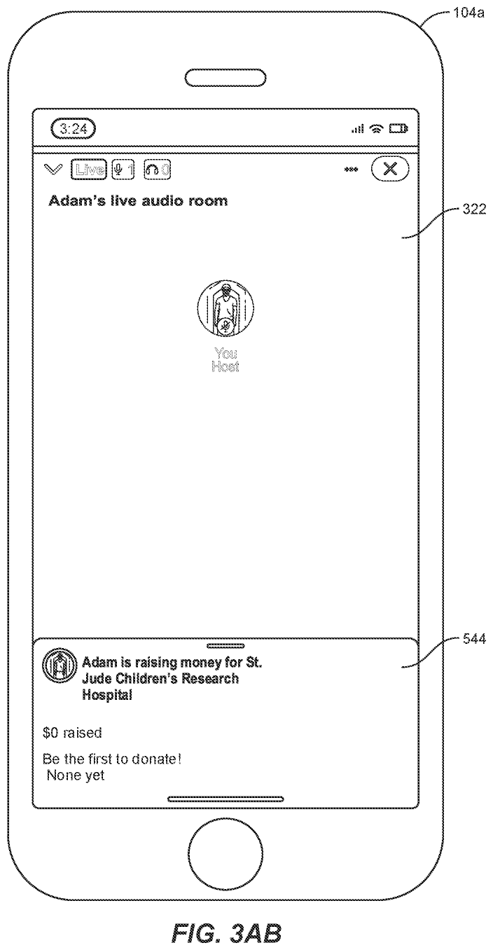

The interactive session system 112 can further perform an act 230 of admitting the listener to the live interactive session. For example, the interactive session system 112 can admit the listener in response to detecting a selection of a “join now” option associated with: the listener's calendar (e.g., within the social networking system application 120c), a notification provided to the listener, or a listing of currently-live interactive sessions. In one or more embodiments, the interactive session system 112 admits the listener by generating and providing an interactive session interface including the interactive session components described below with reference to FIGS. 3A-3N.

During the live interactive session, the interactive session system 112 can further perform the act 232 of detecting social networking system responses. For example, the interactive session system 112 can detect selections of social networking system response elements (e.g., thumbs-ups, hearts, etc.). Additionally, the interactive session system 112 can detect other social networking system responses and activity including, but not limited to, comments within the comment thread associated with the interactive session, selections of social networking system options to “follow” another interactive session participant including the host(s) and speaker(s), selections of social networking system options to “like” another interactive session participant, selections of social networking system options to share the interactive session with other social networking system users, and so forth.

Additionally, during the interactive session, the interactive session system 112 can detect and facilitate other types of interactions by listeners. For example, in one or more embodiments, the interactive session system 112 can provide additional information about the host in response to one or more detected selection by a listener. Additionally, the interactive session system 112 can enable a listener to “raise a hand” by detecting a listener selection of a particular option indicating that listener's desire to be recognized by the host and/or speaker.

As mentioned above, FIG. 2D illustrates a series of acts 234 performed by the interactive session system 112 relative to a listener of an interactive session capture. As discussed above, the interactive session system 112 generates an interactive session capture of an interactive session upon completion of the interactive session. A “listener of an interactive session capture” may refer to an interactive session system user who accesses an interactive session capture to listen to the recorded audio stream of the interactive session as well as to view and engage with other interactive features of the interactive session capture.

In one or more embodiments, the interactive session system 112 can perform an act 236 of providing a display option associated with interactive session capture to the listener. For example, the interactive session system 112 can generate and provide the display option in a customized post or notification within the listener's social networking system application 120c. In additional embodiments, the interactive session system 112 can generate and provide the display option as part of a listing or repository of interactive session captures available to the listener.

In response to a detected selection of the display option associated with an interactive session capture, the interactive session system 112 can further perform an act 238 of generating an interactive session playback interface associated with the interactive session capture. For example, the interactive session system 112 can generate the interactive session playback interface including a playback timeline associated with the interactive session, thumbnails associated with the participants of the interactive session, various views associated with the interactive session (e.g., a speaker view, a comment view), a transcription of the audio stream of the interactive session, and various social networking system response options.

In response to a detected selection of a play option associated with the playback timeline in the interactive session playback interface, the interactive session system 112 can perform an act 240 of initiating playback of the interactive session capture. For example, the interactive session system 112 can play a recording of the audio stream of the interactive session, while simultaneously updating the interactive session playback interface to reflect activities that occurred during the interactive session. In one embodiment, the interactive session system 112 can continuously update the interactive session playback interface to reflect participants who joined and/or left the interactive session at various points during the interactive session. The interactive session system 112 can also update the interactive session playback interface to reflect when each comment was added to the comment thread associated with the interactive session.

In one or more embodiments, the interactive session system 112 can perform an act 242 of continuously updating a highlight element in the interactive session playback interface to indicate an active speaker during playback of the interactive session capture. For example, the interactive session system 112 can update a highlight element to indicate a speaker associated with every increment in the recorded audio stream of the interactive session. The interactive session system 112 can update the highlight element by one or more of: adding a visual indicator to a thumbnail associated with a current speaker, changing a color of a current speaker's name within the interactive session playback interface, adding a tag or other indicator associated with a current speaker to the transcription of the audio stream of the interactive session, changing a size of the thumbnail associated with a current speaker, or otherwise visually indicating the current speaker within the interactive session playback interface.

In at least one embodiment, the interactive session system 112 further performs an act 244 of detecting additional social networking system responses during playback of the interactive session capture. For example, as mentioned above, the interactive session system 112 generates an interactive session capture such that the interactive session capture is not limited to the original interactive session but can also be updated to include additional interaction information. To illustrate, the interactive session system 112 can detect and update an interactive session capture to include additional social networking system responses during playback of the interactive session capture. For instance, the interactive session system 112 can detect selection of social networking system response elements during playback of the interactive session capture. In one or more embodiments, the interactive session system 112 can further detect comments added to interactive session comment thread during playback of the interactive session capture.

As discussed above, the interactive session system 112 can generate and support interactive session accessible by hosts, speakers, and audience members. The interactive session system 112 can also generate and distribute interactive session captures upon completion of the interactive sessions. FIGS. 3A-3N illustrate graphical user interfaces generated and provided by the interactive session system 112 in connection with interactive sessions and interactive session captures.

For example, as shown in FIG. 3A, the interactive session system 112 can generate an interactive session configuration interface 304 and overlay the interactive session configuration interface 304 on a social networking system interface 303 on a display 302a of the computing device 104a (e.g., a computing device of an interactive session host). In one or more embodiments, the interactive session system 112 can generate the interactive session configuration interface 304 in response to a detected interaction with an option to configure an interactive session via the social networking system application 120a on the computing device 104a.

As further shown in FIG. 3A, the interactive session system 112 can generate the interactive session configuration interface 304 including various options and controls. For example, the interactive session system 112 can generate the interactive session configuration interface 304 including a title control 306, a start time control 308, an audience configuration tool 310, a speaker configuration listing 312, and an initiation button 314.

To illustrate, the interactive session system 112 can determine a title or topic of an upcoming interactive session based on input received via the title control 306. For example, in one embodiment, the interactive session system 112 can utilize this input verbatim as the title for the upcoming interactive session. In additional embodiments, the interactive session system 112 can automatically determine a topic for the upcoming interactive session based on the input in the title control 306. For example, the interactive session system 112 can utilize natural language processing or other computing models to extract one or more keywords or intents from the input received via the title control 306. The interactive session system 112 can then generate a title or topic for the upcoming interactive session based on the extracted keywords or intents.

Similarly, the interactive session system 112 can determine a start time for the upcoming interactive session via the start time control 308. For example, the interactive session system 112 can determine both a date and time for the upcoming interactive session to start based on the input received via the start time control 308. In additional embodiments, the interactive session system 112 can determine a duration of the upcoming interactive session from the input received via the start time control 308. Additionally, in at least one embodiment, the interactive session system 112 can immediately initiate the interactive session in response to determining that the input received via the start time control 308 is within a threshold period of time from the current time (e.g., within the next 60 seconds).

In one or more embodiments, the interactive session system 112 determines which audience members (e.g., listeners) to invite or admit based on detected interactions with the audience configuration tool 310. For example, in one embodiment, the interactive session system 112 can initially set the audience configuration tool 310 to a default audience (e.g., “Your Friends”). In additional embodiments and in response to a detected selection of the audience configuration tool 310, the interactive session system 112 can provide additional controls or an additional interface by which the user of the computing device 104a can select alternate or additional groups (e.g., “Friends of Friends”), and/or indicate individual audience members. In additional embodiments—as discussed below with regard to FIGS. 3O-3R—the audience configuration tool 310 can include a different arrangement of additional or alternate features and tools.

As further shown in FIG. 3A, the interactive session system 112 can determine speakers to invite and/or admit into the upcoming interactive session based on detected interactions with the speaker configuration listing 312 within the interactive session configuration interface 304. For example, in one embodiment, the interactive session system 112 auto-populates the speaker configuration listing 312 with speakers who have spoken in previous interactive sessions hosted by the user of the computing device 104a. In additional embodiments, the interactive session system 112 automatically identifies the speakers in the speaker configuration listing 312 by analyzing social networking system information associated with the speakers in light of the title or topic of the upcoming interactive session. Furthermore, the interactive session system 112 can add additional speakers to the speaker configuration listing 312 in response to detected interactions with a search function associated with the speaker configuration listing 312. The interactive session system 112 can determine that selected speakers in the speaker configuration listing 312 should be admitted to the upcoming interactive session with speaker-level privileges (e.g., can speak, can present digital media, can invite audience members).

Moreover, the interactive session system 112 can finalize the configurations for the upcoming interactive session in response to a detected selection of the initiation button 314. For example, in response to a detected selection of the initiation button 314, the interactive session system 112 can generate and provide notifications associated with the upcoming interactive session to speakers and audience members indicated within the interactive session configuration interface 304. In additional embodiments and depending on privacy settings associated with the upcoming interactive session, the interactive session system 112 can further generate and provide social networking system newsfeed posts associated with the upcoming interactive session within newsfeeds of social networking system users.

To illustrate, FIG. 3B shows a social networking system newsfeed post 318 generated by the interactive session system 112 that is associated with an upcoming interactive session within a newsfeed interface 316 on a display 302c of a computing device 104c (e.g., a computing device associated with a potential audience member or listener of the interactive session). For example, in one or more embodiments, the interactive session system 112 can predict that the user of the computing device 104c will likely be interested in the upcoming interactive session associated with the newsfeed post 318. Accordingly, the interactive session system 112 can generate and provide the newsfeed post 318 within the newsfeed of the user of the computing device 104c (e.g., via the social networking system application 120c installed thereon).

As shown in FIG. 3B, the interactive session system 112 can generate the newsfeed post 318 including information associated with the host, information associated with one or more speakers of the interactive session, the date and time for the interactive session, the topic or title of the interactive session, and other digital media associated with the interactive session (e.g., a digital image, a digital video clip). The interactive session system 112 further generates the newsfeed post 318 including various social networking system controls. For example, in response to a detected selection of an interested button 320, the interactive session system 112 can add the user of the computing device 104c to the audience for the interactive session. In additional embodiments, the interactive session system 112 can schedule additional notifications regarding the interactive session for the user of the computing device 104c in response to a detected selection of the interested button 320. Moreover, the social networking system 110 can register additional social networking system activity in response to detected selection of other social networking system controls (e.g., likes, comments, shares).

Once the interactive session system 112 initiates the live interactive session (e.g., in response to any of the triggers discussed above), the interactive session system 112 can generate and provide an interactive session interface including various features to the computing devices 104a, 104b, and 104c. For example, as shown in FIG. 3C, the interactive session system 112 can generate an interactive session interface 322 for display on the host computing device 104a.

In one or more embodiments, the interactive session system 112 can generate the interactive session interface 322 including interface portions dedicated to interactive session participants with various privileges and connections. For instance, the interactive session system 112 can generate the interactive session interface 322 including a speaker portion 324 including thumbnails 325a, 325b, 325c, 325d, and 325e associated with interactive session participants who have speaking permissions within the interactive session (e.g., the host and speakers). Additionally, the interactive session system 112 can generate the interactive session interface 322 including a connected participant portion 326 including thumbnails of participants who are connected to the participants shown in the speaker portion 324 via the social networking system 110 (e.g., participants who are “followed” by the speakers within the social networking system 110). In one or more embodiments, the interactive session system 112 further generates the interactive session interface 322 including an audience portion 328 including thumbnails or other identifiers associated with listeners or audience members of the interactive session who have no speaking permissions.

In at least one embodiment, as shown in FIG. 3C, the interactive session system 112 continuously updates a highlight element 345 within the speaker portion 324 to indicate a currently active speaker. For example, the interactive session system 112 can analyze the audio stream of the live interactive session to determine which of the listed speakers is actively speaking. In response to determining that a particular speaker is actively speaking, the interactive session system 112 can update or re-render the interactive session interface 322 such that the highlight element 345 is associated with the thumbnail of the active speaker. For instance, the interactive session system 112 can generate the highlight element 345 to approximate a stylized thumbnail border (e.g., a “halo”). In additional embodiments, the interactive session system 112 can generate the highlight element 345 to make the associated thumbnail appear enlarged, to change a color of the active speaker's name, to add an animated overlay to the active speaker's name or thumbnail, and so forth.

As further shown in FIG. 3C, the interactive session system 112 generates the interactive session interface 322 on the host computing device 104a including various informational indicators and controls. For example, the interactive session system 112 can generate the interactive session interface 322 including a live indicator 330 showing that the interactive session is currently live, a speaker indicator 332 showing a number of participants with speaking permissions, and an audience indicator 334 showing a number of participants who can hear the interactive session.

The interactive session system 112 can further generate the interactive session interface 322 including a mute control 336, an add speaker control 338, a forward control 340, and a social networking system response control 342. For example, in response to a detected selection of the mute control 336, the interactive session system 112 can mute a microphone of the host computing device 104a. Additionally, in response to a detected selection of the forward control 340, the interactive session system 112 can generate and provide a notification associated with the interactive session to additional users indicated by the interactive session host. Moreover, in response to a detected selection of the social networking system response control 342, the interactive session system 112 can generate and display one or more ephemeral social networking system response elements 344.

In at least one embodiment, in response to a detected selection of the add speaker control 338, the interactive session system 112 can invite an additional speaker indicated by the interactive session host to join the interactive session. For example, as shown in FIG. 3D, the interactive session system 112 can generate a speaker invitation overlay 346 for display on an audience member (e.g., a listener) computing device 104c. To illustrate, the interactive session system 112 can generate the speaker invitation overlay 346 including information about the interactive session (e.g., the host name, rule and guidelines associated with the interactive session). In response to a detected selection of the not now button 348, the interactive session system 112 can remove the overlay from the interactive session interface 322. In response to a detected selection of the join as speaker button 350, the interactive session system 112 can update the interactive session interface 322 on the computing device 104c to include a thumbnail associated with the user of the computing device 104c within the speaker portion 324 (e.g., as shown in FIG. 3C). The interactive session system 112 can also activate or un-mute a microphone of the computing device 104c along with updating the interactive session permissions and privileges associated with the user of the computing device 104c.

In one or more embodiments, the interactive session system 112 can also update or modify the interactive session interface 322 on the listener computing device 104c to include additional or alternative features based on the interactive session permissions associated with the user of the computing device 104c. For example, as shown in FIG. 3E, the interactive session system 112 can generate the interactive session interface 322 to include fewer features than are provided on the host computing device 104a (e.g., as shown in FIG. 3C). To illustrate, the interactive session system 112 can generate the interactive session interface 322 including the speaker portion 324—including the highlight element 345, the connected participant portion 326, and the audience portion 328. The interactive session system 112 can further generate the interactive session interface 322 including the hand raise control 352, the forward control 340, and the social networking system response control 342. In this embodiment, however, the interactive session system 112 can generate the interactive session interface 322 without the add speaker control 338 (e.g., shown in FIG. 3A) in response to determining that the user of the computing device 104c does not have permission to invite additional speakers to speak within the interactive session.

Additionally, as shown in FIG. 3F, the interactive session system 112 can generate and provide a transcription 356 overlaid on the interactive session interface 322. For example, in one embodiment, the interactive session system 112 can utilize machine learning, natural language processing, or similar to transcribe the audio stream of the interactive session in real-time. In that embodiment, the interactive session system 112 can provide the transcription 356 as closed captioning overlaid on the interactive session interface 322. For instance, the interactive session system 112 can provide the transcription 356 in response to a detected selection of a closed captioning option within the interactive session interface 322.

Additionally or alternatively, the interactive session system 112 can provide other language-based features. For example, in one embodiment, the interactive session system 112 can generate and provide real-time translations of words spoken during an interactive session. To illustrate, the interactive session system 112 can generate real-time translations in a text-based format (e.g., similar to the transcription overlay discussed above) and/or in an auditory voice-over format. Moreover, in some embodiments, the interactive session system 112 can provide or enable features or actions within an interactive session in response to detecting that one or more predetermined words or phrases have been spoken.

As further shown in FIG. 3F, the interactive session system 112 can also provide additional or alternative controls within the interactive session interface 322. For example, in addition to the forward control 340 and the social networking system response control 342, the interactive session system 112 can generate the interactive session interface 322 including a hand raise control 352, and a star control 354. In one or more embodiments, and in response to a detected selection of the hand raise control 352, the interactive session system 112 can generate a notification for a currently active speaker to recognize the user of the computing device 104c in some way (e.g., answer a question from the comment section from the user of the computing device 104c). Additionally, in response to a detected selection of the star control 354, the interactive session system 112 can make additional emphasizing features available within the interactive session interface 322. For example, the interactive session system 112 can enable personal bookmarking such that the user of the computing device 104c can easily find specific portions of the interactive session later during playback of the corresponding interactive session capture.

As mentioned above, the interactive session system 112 can enable interactive session participants to access and add to a comment thread associated with the interactive session. For example, as shown in FIG. 3G and in response to a detected selection of a comment option associated with the interactive session, the interactive session system 112 can update the interactive session interface 322 on the computing device 104c by replacing the features and controls of the interactive session interface 322 (e.g., as shown with regard to FIGS. 3A-3F) with a comment view 358 including a comment thread 360 and an input text box 362.

In one or more embodiments, the interactive session system 112 generates the comment thread 360 including comments submitted by any participant of the interactive session (e.g., the host, speakers, and/or audience members) in chronological order with the most recent comment at the bottom of the thread. In response to detected input in the input text box 362, the interactive session system 112 can add a new comment to the comment thread 360. In at least one embodiment, the interactive session system 112 can grant certain interactive session participants (e.g., the host and/or the speakers) with editing permissions relative to the comment thread 360 such that those participants can remove comments that may be inappropriate, abusive, etc.

In one or more embodiments, the interactive session system 112 can generate an interactive session that includes visual presentation capabilities. For example, as shown in FIG. 3H, the interactive session system 112 can grant permission to the host(s) and/or speakers to broadcast visual or additional information to the participants of the interactive session. To illustrate, in response to a detected selection of a presentation option by the host(s) and/or currently active speaker, the interactive session system 112 can generate a link to the host(s) and/or currently active speaker's presentation materials. The interactive session system 112 can further broadcast the generated link to all or specific (e.g., as specified by the host(s) and/or currently active speaker) interactive session participants. As shown in FIG. 3H, the interactive session system 112 can broadcast that link by generating and providing a presentation link overlay 364 on the interactive session interface 322.

In at least one embodiment, in response to a detected selection of a go to link button 366 within the presentation link overlay 364, the interactive session system 112 can change the display focus of the computing device 104c away from the interactive session interface 322 to a web browser directed to the web address in the link. In that embodiment, the interactive session system 112 can continue to play the audio stream of the interactive session, even though the interactive session interface 322 no longer has display focus. In additional embodiments, the interactive session system 112 can generate a picture-in-picture overlay including a reduced-size web browser directed to the web address in the link. In yet further additional embodiments, the interactive session system 112 can access the presentation materials (e.g., spreadsheets, word processing documents, slides, digital media) at the web address in the link and overlay the presentation materials on the interactive session interface 322.

As mentioned above, the interactive session system 112 can provide a back channel for the host(s) and speakers of an interactive session to communicate among themselves that is not accessible by the listeners (e.g., other audience members) of the interactive session. For example, as shown in FIG. 3I, the interactive session system 112 can generate the interactive session interface 322 including an additional back channel control 368 on the broadcaster (e.g., speaker) computing device 104b. In response to a detected selection of the back channel control 368, the interactive session system 112 can replace the interactive session interface 322 with a back channel interface 370, as shown in FIG. 3J.

In one or more embodiments, as shown in FIG. 3J, the interactive session system 112 generates the back channel interface 370 including features specific the hosts and/or speakers of the interactive session. For example, the interactive session system 112 can generate the back channel interface 370 including a speaker comment thread 372 where the host and/or speakers can communicate among themselves in a thread that is not accessible by other interactive session participants. For instance, in response to detected input within the text input box 374, the interactive session system 112 can add a comment from the user of the computing device 104b to the bottom of the speaker comment thread 372.

Additionally, the interactive session system 112 can generate the back channel interface 370 including an informational overlay 376 including information associated with the currently-live interactive session (e.g., the current number of audience members, the current number of speakers). The interactive session system 112 can also generate the back channel interface 370 including a toggle 378. For example, in response to a detected selection of the toggle 378, the interactive session system 112 can replace the back channel interface 370 with the interactive session interface 322. In at least one embodiment, the interactive session system 112 can continue to play the audio stream of the interactive session while the back channel interface 370 has display focus on the computing device 104b.

In one or more embodiments, the interactive session system 112 can provide a green room prior to initiation of the live interactive session. For example, as shown in FIG. 3K, the interactive session system 112 can generate and provide a green room interface 380 to the host and/or speakers of the interactive session as a place for those interactive session participants to assemble and communicate prior to the interactive session going live for the other audience members of the interactive session. For example, and similar to the interactive session interface 322, the interactive session system 112 can generate the green room interface 380 including the speaker thumbnails 325a-325e. The interactive session system 112 can also continually update the highlight element 345 (e.g., the “halo”) to surround the thumbnail of a currently active speaker within the green room interface 380.

To illustrate, prior to a scheduled interactive session, the interactive session system 112 can generate the green room interface 380 and provide the host and speakers with access to the green room interface 380. The host and speakers can access the green room interface 380 to assemble one-by-one and discuss last minute agenda items, presentation accommodations and so forth. As shown in FIG. 3K, the interactive session system 112 generates the controls 336 and 338 within the green room interface 380 such that the interactive session system 112 can mute computing devices of the host and/or speakers or generate invitations for additional speakers to join the green room.

In one or more embodiments, the interactive session system 112 can further generate the green room interface 380 to include a live control 382. In response to a detected selection of the live control 382 by a host and/or speaker, the interactive session system 112 can generate and provide a live configuration overlay 383, as shown in FIG. 3L. For example, the interactive session system 112 can generate the live configuration overlay 383 with last-minute information and configuration options. For instance, the interactive session system 112 can generate the live configuration overlay 383 with controls to edit a description of the interactive session and/or modify the accessibility of the interactive session. In response to a detected selection of a go live button 384 within the live configuration overlay 383, the interactive session system 112 can simultaneously replace the green room interface 380 with the interactive session interface 322 on all computing devices of the host and/or speakers in the green room. The interactive session system 112 can also simultaneously activate a microphone of one or more of those computing devices. At that point, the audience of listeners may or may not already be assembled within the interactive session.

Upon the conclusion of an interactive session (e.g., either scheduled to automatically end or in response to a host selection), the interactive session system 112 provides the host with various options. For example, as shown in FIG. 3M and upon the conclusion of an interactive session, the interactive session system 112 can generate and provide an interactive session capture configuration interface 386. In one or more embodiments, the interactive session system 112 can generate the interactive session capture configuration interface 386 including options for the host to rate the audio quality of the now-concluded interactive session, and options for generating and distributing a capture of the now-concluded interactive session. For example, in response to a detected selection of the post live audio option 388a, the interactive session system 112 can generate and distribute an interactive session capture of the now-concluded interactive session. In one or more embodiments, the host can further configure how the interactive session capture is distributed or who has access to the interactive session capture within the social networking system 110 (e.g., everyone, friends, participants in the original interactive session). In response to a detected selection of the delete audio option 388b, the interactive session system 112 can exit the interactive session capture configuration interface 386 and return display focus of the computing device 104a to the social networking system application 120a, or to another application.

In response to the interactive session system 112 generating and distributing an interactive session capture, one or more users can access the interactive session capture for playback and further interaction. For example, in one embodiment, the interactive session system 112 can distribute an interactive session capture within the social networking system 110 (e.g., via social networking system users' newsfeeds). In response to a detected selection of a newsfeed post associated with the interactive session capture, the interactive session system 112 can initiate playback of the capture.

For example, as shown in FIG. 3N, the interactive session system 112 can generate and provide an interactive session playback interface 390 on a display of the listener computing device 104c. In one or more embodiments, the interactive session system 112 can generate the interactive session playback interface 390 including speaker thumbnails 325a, 325b and a playback timeline 394 within an audio control portion 392.

In response to a detected selection of a playback control 391 within the audio control portion 392 (e.g., the play button), the interactive session system 112 can initiate playback of the interactive session capture. For example, the interactive session system 112 can initiate playback of a recorded audio stream of the now-concluded interactive session. In some embodiments, the interactive session system 112 can include additional playback functionality associated with the playback control 391. For example, the interactive session system 112 can include controls within the audio control portion 392 for adjusting playback speed and/or playback volume during playback of the now-concluded interactive session.

The interactive session system 112 can also update the interactive session playback interface 390 to reflect how the interactive session interface (e.g., such as the interactive session interface 322 shown in FIGS. 3C-3H) changed during the original interactive session. For instance, in one or more embodiments and during playback of the interactive session capture, the interactive session system 112 can continuously update the highlight element 345 associated with the thumbnails 325a, 325b to indicate a current active speaker of the interactive session capture. For example, the interactive session system 112 can analyze the audio stream and/or additional metadata associated with the interactive session capture to determine which portions of the audio stream were spoken by which speaker. The interactive session system 112 can then update the highlight element 345 each time a new speaker speaks within the interactive session capture.

In one or more embodiments, the interactive session system 112 can continuously update other portions of the interactive session playback interface 390 during playback of the interactive session capture. For example, the interactive session system 112 can add or remove thumbnails to indicate when speakers joined or left the now-concluded interactive session. The interactive session system 112 can also update the interactive session playback interface 390 to display the social networking system response elements (e.g., the floating thumbs ups, hearts, and so forth) to indicate when those social networking system response elements were selected during the now-concluded interactive session.

The interactive session system 112 can further generate the interactive session playback interface 390 to include additional interactive features. For example, the interactive session system 112 can generate the interactive session playback interface 390 with closed caption option 393. In response to a detected selection of the closed caption option 393, the interactive session system 112 can update the interactive session playback interface 390 to include the transcription 356 of the audio stream of the interactive session capture. For instance, the interactive session system 112 can continuously update the interactive session playback interface 390 to display a portion of the transcription 356 that corresponds with the currently playing portion of the audio stream of the interactive session capture.

Additionally, as shown in FIG. 3N and in response to a detected selection of a speaker view option associated with the interactive session capture, the interactive session system 112 can generate the interactive session playback interface 390 to include a participant listing 396 including speaker elements 398a, 398b, 398c, 398d, and 398e. In one or more embodiments, the interactive session system 112 can generate each of the speaker elements 398a-398e with a name of the corresponding participant, a title of the corresponding participant (e.g., host, speaker, audience), an index of when the corresponding participant speaks during the interactive session capture relative to the audio stream of the interactive session capture, and a social networking system control corresponding to the participant. In one or more embodiments, the interactive session system 112 determines each speaker's index based on an analysis of the audio stream of the interactive session capture and/or based on the metadata associated with the interactive session capture. Additionally, the interactive session system 112 can update the social networking system control associated with each speaker to reflect social networking system options associated with the corresponding participant.

To illustrate, the interactive session system 112 can update the social networking system control within each speaker element 398a-398e to reflect: whether the user of the computing device 104c is connected with the participant corresponding to that speaker element via the social networking system 110 (e.g., “following”), whether the user of the computing device 104c can form a connection with the participant corresponding to that speaker element via the social networking system 110 (e.g., “follow”), or whether the user of the computing device 104c can access a profile for the participant corresponding to that speaker element within the social networking system 110 (e.g., “see profile”). Thus, in response to a detected selection of a social networking system control within a speaker element associated with a particular participant, the interactive session system 112 can generate requests for the social networking system 110, or transfer display focus of the computing device 104c to the social networking system application 120c installed thereon. In additional embodiments, the interactive session system 112 can further generate the participant listing 396 to include audience members (e.g., listeners) of the now-concluded interactive session.

As further shown in FIG. 3N, the interactive session system 112 can generate the interactive session playback interface 390 including a comment option 397 associated with the interactive session capture. For example, in response to detected input within a text box of the comment option 397, the interactive session system 112 can replace, during continued playback of the interactive session capture, the interactive session playback interface 390 with a comment view including the comment thread of the now-concluded interactive session. The interactive session system 112 can further add the new comment from the comment option 397 to the existing comment thread. As such, the interactive session system 112 enables additional comments to be added to an original comment thread during playback of the interactive session capture after the original interactive session has concluded.

Similarly, the interactive session system 112 can generate the interactive session playback interface 390 including the social networking system response control 342. In response to detected selections of the social networking system response control 342, the interactive session system 112 can add one or more social networking system response elements (e.g., floating thumbs, hearts, and so forth) at corresponding playback points within the interactive session capture in addition to the social networking system response elements that occurred during the original interactive session.

As mentioned above, the interactive session system 112 can include some additional or alternative features to those previously described. For example, in one or more embodiments (as illustrated in FIGS. 3O-3R), the interactive session system 112 can include configuration tools that enable an interactive session host to share a live interactive session via an ephemeral content collection associated with the host. Additionally, in some embodiments (as illustrate in FIGS. 3S-3AB), the interactive session system 112 can include configuration tools that enable an interactive session host to raise money for a particular cause during an interactive session. Both of these embodiments are now described.

For example, as shown in FIG. 3O, the interactive session system 112 can generate an alternative view of the interactive session configuration interface 304 overlaid on the social networking system interface 303 of the computing device 104a. In one or more embodiments, the interactive session system 112 can generate the interactive session configuration interface 304 to include an ephemeral sharing option 502, as well as alternative audience options 504.

In more detail, in response to a detected selection of the ephemeral sharing option 502, the interactive session system 112 can broadcast the interactive session associated with the interactive session configuration interface 304 (e.g., once the interactive session is initiated) via an ephemeral content collection associated with the interactive session host (e.g., the user of the computing device 104a). In one or more embodiments, an ephemeral content collection can include digital media that is available to co-users of a social networking system user for a predetermined amount of time (e.g., 24 hours). After the predetermined amount of time elapses for a particular digital media item in an ephemeral content collection, the social networking system 110 can remove that digital media item from the ephemeral content collection.

Accordingly, in response to a detected selection of the ephemeral sharing option 502 and initiation of the associated interactive session, the interactive session system 112 can add a digital media item to the host's ephemeral content collection associated with that interactive session. In one or more embodiments, the interactive session system 112 can generate the digital media item to include a link to the live interactive session while the interactive session is live. Upon completion of the interactive session—and if the digital media item is still within its predetermined amount of time—the interactive session system 112 can update the digital media item to include a link to the interactive session capture of the now-completed interactive session.

As further shown in FIG. 3O, the interactive session system 112 can generate the social networking system interface 303 including the alternative audience options 504. In one or more embodiments, the interactive session system 112 can generate the alternative audience options 504 including selectable options associated with different individuals or groups associated with the interactive session host. In response to detected selections of one or more of the options, the interactive session system 112 can broadcast information associated with the configured interactive session to the associated individuals or groups via various social networking system channels. For example, in response to a detected selection of the option associated with “Friends,” the interactive session system 112 can broadcast information associated with the configured interactive session to the host's social networking system friends via generated posts within their newsfeeds. The interactive session system 112 can also make information associated with the interactive session viewable to the host's social networking system friends via the host's social networking system profile. The interactive session system 112 can also enable search results associated with the interactive session available to the host's social networking system friends.

In response to a detected selection of a save button 506, the interactive session system 112 can update the interactive session configuration interface 304 to include the features discussed above with regard to FIG. 3A. For example, as shown in FIG. 3P, the interactive session system 112 can update the interactive session configuration interface 304 to include the title control 306, the start time control 308, the audience configuration tool 310, and the speaker configuration listing 312. In one particular embodiment, for example, the interactive session host may configure an interactive session to include only themselves as audience members and to be broadcast via their ephemeral content collection to their social networking system friends. In that embodiment, as demonstrated by the audience configuration tool 310 shown in FIG. 3P, the interactive session system 112 may notify the host's social networking system friends or “followers” of the ephemeral content collection media item associated with the interactive session.

To illustrate, as shown in FIG. 3Q, in response to the configured interactive session going live, the interactive session system 112 can add various updates and items to the social networking system interface 303 of the interactive session host. For example, the interactive session system 112 can update the social networking system interface 303 to include a profile notification 510 associated with the interactive session. As such, any social networking system user with permission to view the host's social network system profile can see and select the profile notification 510 associated with the interactive session.

Additionally, the interactive session system 112 can add an ephemeral content item 514 associated with the interactive session to the host's ephemeral content collection 512. As shown in FIG. 3Q, the host's ephemeral content collection 512 can include multiple ephemeral content items associated with both the host and the host's friends. Furthermore, the interactive session system 112 can include a profile update 516 associated with the interactive session and an overlay 518 associated with the interactive session. In one or more embodiments, the interactive session system 112 can generate and provide the interactive session interface 322 for the host and/or another co-user or group of co-users in response to a detected selection of one or more of the profile notification 510, the ephemeral content item 514, the profile update 516, and the overlay 518.

For example, as shown in FIG. 3R, in response to a detected selection by the host of the ephemeral content item 514, the interactive session system 112 can generate and provide an ephemeral content item interface 520. In one or more embodiments, the interactive session system 112 can generate the ephemeral content item interface 520 including a listening option 522, an ephemeral content collection option 524, and an interactive session notification 526.

In more detail, the interactive session system 112 can generate the listening option 522 to enable the host to toggle back and forth between speaking and listening (e.g., to other invited speakers within the interactive session). Additionally, the interactive session system 112 can generate the ephemeral content collection option 524 to enable the host to either add additional content to the ephemeral content item associated with the interactive session during the interactive session, or to create an additional ephemeral content item during the interactive session. In at least one embodiment, the interactive session system 112 can generate the interactive session notification 526 with information informing the host that the interactive session is currently live, the title of the interactive session, and an indication of who can listen to the interactive session.

Additionally, the interactive session system 112 can further generate the interactive session notification 526 to include a thumbnail for the host and each speaker within the interactive session. The interactive session system 112 can also include and update the highlight element 345 to indicate which of the host and speakers is currently speaking. As further shown in FIG. 3R, the interactive session system 112 can generate the ephemeral content item interface 520 including a viewer control 528 that indicates a number of audience members who are currently tuned in to the interactive session, and a comment control 530 that enables the host, speakers, and/or audience members to add and view comments associated with the interactive session.

As mentioned above, the interactive session system 112 can include additional interactive session features that enable the host, speakers, and/or audience members of an interactive session to raise and/or donate funds for various groups (e.g., charities, non-profits, fundraisers). For example, as shown in FIG. 3S, during the interactive session configuration process (e.g., as discussed above with regard to FIG. 3A), the interactive session system 112 can generate and provide a donation configuration overlay 532 on the social networking system interface 303 of the computing device 104a. For instance, as shown in FIG. 3S, the interactive session system 112 can generate the donation configuration overlay 532 including various premium features such as the raise money premium feature 534.

In one or more embodiments and in response to a detected selection of the raise money premium feature 534, the interactive session system 112 can update the donation configuration overlay 532 to include various donation configuration options, as shown in FIG. 3T. For example, the interactive session system 112 can generate donation configuration options 538 under one or more selectable categories 534a and 534b.

As shown in FIG. 3T, the interactive session system 112 can generate the donation configuration options 538 based on various signals. For example, the interactive session system 112 can generate some of the donation configuration options 538 based on organizations to which friends of the interactive session host have previously donated. Additionally or alternatively, the interactive session system 112 can generate some of the donation configuration options 538 based on common or popular organizations to which social networking system users have donated. In at least one embodiment, the interactive session system 112 can filter these common or popular organizations based on geographic location and/or demographic distribution. Additionally, in additional embodiments, the interactive session system 112 can filter the common or popular organizations based on interests of the host (e.g., as determined by the social networking system 110 based on the host's social networking system activity).

In response to a detected selection of a donation configuration option, the interactive session system 112 can again update the donation configuration overlay 532 to include an indicator 542 of the selected organization within the raise money premium feature 534, as shown in FIG. 3U. Additionally, the interactive session system 112 can update the donation configuration overlay 532 to include a toggle 540 associated with the raise money premium feature 534. For example, in response to a detected selection of the toggle 540, the interactive session system 112 can enable or disable the raise money premium feature 534 associated with the selected organization.

In response to a detected selection of the go live button 384, the interactive session system 112 can initialize the configured interactive session while attaching the configured raise money premium feature 534 to the initialized interactive session. For example, the interactive session system 112 can update the social networking system interface 303 on the computing device 104a to include a minimized version of the donation configuration overlay 532 in addition to the profile notification 510, and the ephemeral content item 514 within the ephemeral content collection 512 as discussed above. In one or more embodiments, the interactive session system 112 can toggle the donate features on and off during the live interactive session in response to a detected selection of the toggle 540 within the minimized version of the donation configuration overlay 532 overlaid on the host's profile. In one or more embodiments, as shown in FIG. 3W, the interactive session system 112 can remove the donation configuration overlay 532 from the social networking system interface 303 in response to a detected selection of the donation configuration overlay 532 (e.g., a slide down touch gesture).

While the interactive session system 112 is initializing the configured interactive session, the interactive session system 112 can provide various updates to the interactive session host. For example, as shown in FIG. 3X, while the interactive session system 112 is initializing the interactive session, the interactive session system 112 can also provide an update 542 overlaid on the interactive session interface 322 informing the host that the interactive session is still being initialized. Additionally, as shown in FIG. 3Y, the interactive session system 112 can continue to update the interactive session interface 322 during initialization by adding the thumbnail 325 associated with the host. Additionally, as shown in FIG. 3Z, the interactive session system 112 can further update the indicator 542 to indicate that the interactive session has started.

In one or more embodiments, in response to the detected configuration of the raise money premium feature 534, the interactive session system 112 can add a fundraising overlay 544 on the interactive session interface 322 as shown in FIG. 3AA. For example, the interactive session system 112 can add the fundraising overlay 544 to the interactive session interface 322 on the computing device 104a (e.g., the host's computing device) as well as on interactive session interfaces on the computing device 104b (e.g., a speaker's computing device and on the computing device 104c (e.g., an audience member's computing device). Accordingly, in response to detected selections with any of these fundraising overlays 544, the interactive session system 112 can facilitate receipt of donations associated with the organization configured in connection with the raise money premium feature 534. Additionally, as shown in FIG. AB, the interactive session system 112 can continually update the fundraising overlay 544 (e.g., on the computing device 104a and/or on the other computing devices 104b, 104c) to indicate how much money has been donated/raised.

FIG. 4 illustrates a block diagram of the interactive session system 112 operating on the server(s) 102. As shown, the interactive session system 112 can include a graphical user interface generator 402, an interactive session scheduler 404, an audience manager 406, and interactive session manager 408, and a session capture manager 410. Although illustrated as separate elements, one or more of the components 402-410 of the interactive session system 112 may be combined in additional embodiments. Similarly, in additional embodiments, the interactive session system 112 may include additional, fewer, or different components.

In certain embodiments, the interactive session system 112 may represent one or more software applications or programs that, when executed by a computing device, may cause the computing device to perform one or more tasks. For example, and as will be described in greater detail below, one or more of the components 402-410 of the interactive session system 112 may represent software stored and configured to run on one or more computing devices, such as the devices illustrated below in FIG. 4 (e.g., the server(s) 102 and/or the computing devices 104a-104c via the interactive session applications 118a-118c installed thereon). One or more of the components 402-410 of the interactive session system 112 shown in FIG. 4 may also represent all or portions of one or more special-purpose computers configured to perform one or more tasks.

As mentioned above, and as shown in FIG. 4, the interactive session system 112 can include the graphical user interface generator 402. In one or more embodiments, the graphical user interface generator 402 generates and provides user interfaces in connection with interactive sessions and interactive session captures. For example, the graphical user interface generator 402 can generate and provide an interactive session interface 322 to a computing device based on the user-level privileges and permissions associated with a user of that computing device. Similarly, the graphical user interface generator 402 can generate and provide an interactive session playback interface 390 to a computing device include the playback features discussed above.

In one or more embodiments, the graphical user interface generator 402 also updates and modifies user interfaces based on detected user interactions within those user interfaces. For example, based on detected user interfaces, the graphical user interface generator 402 can update an interactive session interface 322 to include a comment view, a real-time transcription overlay, and so forth. Similarly, the graphical user interface generator 402 can update an interactive session playback interface 390 to include a comment view, a speaker view, a real-time transcription overlay, social networking system response elements, and so forth. The graphical user interface generator 402 may also generate additional interfaces associated with the interactive session system 112 such as a green room interface, back channel interface, a configuration interface, an invitation overlay, and so forth.

As mentioned above, and as shown in FIG. 4, the interactive session system 112 can include the interactive session scheduler 404. In one or more embodiments, the interactive session scheduler 404 handles scheduling tasks relative to an interactive session. For example, in response to detected user interactions via the interactive session configuration interface 304 (e.g., as shown in FIG. 3A), the interactive session scheduler 404 can generate a new interactive session object within the interactive session system 112 and/or the social networking system 110 including the configurations received via the interactive session configuration interface 304. In one or more embodiments, the interactive session scheduler 404 generates and provides reminder notifications, calendar items, etc. associated with the scheduled interactive session to the interactive session participants who have been invited by the host and/or have indicated interest in the upcoming interactive session.

As mentioned above, and as further shown in FIG. 4, the interactive session system 112 can include the audience manager 406. In one or more embodiments, the audience manager 406 identifies users who will likely be interested in a particular interactive session, suggests interactive session participants, and generates and provides notifications associated with the particular interactive session to the identified users.

For example, the audience manager 406 can identify a user who will likely be interested in a particular interactive session based on social networking system information associated with that user. To illustrate, the audience manager 406 can access social networking system information associated with the user including, but not limited to: the user's profile information, co-user information (e.g., the user's “friends”), the user's posts, the user's “likes,” the user's comments, the user's marketplace activity, accounts followed by the user, and digital media accessed by the user within the social networking system. Additionally, the audience manager 406 can access information that is specific to interactive sessions and interactive session captures. For example, the audience manager 406 can access information associated with a user's previous attendance or participation in previous interactive sessions, as well as interactive session captures with which the user has engaged. The audience manager 406 can also access interactive session-specific information associated with the user's social networking system co-users (e.g., the user's “friends”) including interactive session in which the co-users have participated or been interested in and interactive session captures with which the co-users have engaged.

The audience manager 406 can utilize machine learning, neural networks, algorithms, knowledge graphs, decision trees, etc. in connection with this information to determine one or more topics, keywords, or subjects in which the user is likely interested. In at least one embodiment, the audience manager 406 can then compare these topics, keywords, or subjects to a configured topic of a scheduled interactive session. In response to determining a threshold correspondence between the topics, keywords, or subjects and the configured topic, the audience manager 406 can determine that the user will likely be interested in the upcoming interactive session.

Additionally, the audience manager 406 can suggest users as interactive session participants. For example, the audience manager 406 can suggest interactive session participants to the interactive session host including, but not limited to, the host's co-users within the social networking system 110, users who have been participants in the host's previous interactive session, and users who were automatically identified in the process described above. In response to the host selecting one or more of the suggested users, the audience manager 406 can generate and provide notifications associated with the upcoming interactive session. For example, the audience manager 406 can generate social networking system posts associated with the upcoming interactive session and can provide those posts to social networking system users who will likely be interested in the interactive session.

As mentioned above, and as shown in FIG. 4, the interactive session system 112 can include the interactive session manager 408. In one or more embodiments, the interactive session manager 408 initiates an interactive session (e.g., based on the configurations within the associated interactive session object), admits participants into the interactive session, streams audio and visual components of the interactive session to the session participants, supports the comment thread and other social networking system responses during the interactive session, identifies currently active speakers during the interactive session, and continuously updates the highlight element associated with the speaker thumbnails to indicate the currently active speaker during the interactive session.

As mentioned above, and as shown in FIG. 4, the interactive session system 112 can include the session capture manager 410. In one or more embodiments, the session capture manager 410 generates interactive session captures, distributes or makes the interactive session captures available, and handles the tasks involved in interactive session capture playback.

For example, the session capture manager 410 can generate an interactive session capture upon completion of an interactive session in various ways. In one embodiment, the session capture manager 410 generates an interactive session capture of an interactive session by recording the audio stream of the interactive session and generating metadata associated with comments, interactions, participant comings and goings, and so forth that occur during the interactive session. The session capture manager 410 can further generate the interactive session capture by packaging this information with the recorded audio stream into an interactive session capture object. In at least one embodiment, the session capture manager 410 can make the interactive session capture object available via the social networking system 110. In additional embodiments, the session capture manager 410 can package this information within the existing interactive session object (e.g., generated by the interactive session scheduler 404) such that the existing interactive session object becomes available as an interactive session capture.

In one or more embodiments, the session capture manager 410 can distribute the interactive session capture (e.g., the interactive session capture object) to various users. For example, the session capture manager 410 can distribute the interactive session capture to users who participated in the interactive session. In additional embodiments, the session capture manager 410 can distribute the interactive session capture to co-users (e.g., “friends”) of the host and/or speakers of the interactive session via the social networking system 110. In yet further additional embodiments, the session capture manager 410 can make the interactive session capture available to social networking system users who will likely be interested in the interactive session capture (e.g., identified via the process described above). In at least one embodiment, the session capture manager 410 can make the interactive session capture available via a repository or archive that can be accessed by social networking system users.

In one or more embodiments, the session capture manager 410 supports playback of an interactive session capture. For example, in response to a detected selection of a display option associated with an interactive session capture, the session capture manager 410 can load the corresponding interactive session capture object within the interactive session playback interface 390 as shown in FIG. 3N. In response to a selection of the playback control 391, the session capture manager 410 can begin playback of the recorded audio stream while simultaneously updating the interactive session playback interface 390 based on the interaction information within the interactive session capture object metadata. For instance, the session capture manager 410 can continuously update the interactive session playback interface 390 based on this metadata such that various interactions and responses that occurred during the original interactive session are mirrored in playback of the interactive session capture. The session capture manager 410 can further continuously determine a currently active speaker, update the highlight element 345 each time the currently active speaker changes.

In one or more embodiments, the session capture manager 410 updates an interactive session capture object based on additional interactions detected during playback of the corresponding interactive session capture. For example, the session capture manager 410 can add additional social networking system responses and comments detected during playback of the interactive session capture to the interaction data and other metadata in the corresponding interactive session capture object. Thus, the session capture manager 410 maintains and updates interactive session capture objects to reflect ongoing interactions with the original interactive session even though the original interactive session is concluded.

As further illustrated in FIG. 4, the server(s) 102 can store and maintain the interactive session system 112 in a memory 108. The memory 108 generally represents any type or form of volatile or non-volatile storage device or medium capable of storing data and/or computer-readable instructions. In one example, the memory 108 may store, load, and/or maintain one or more of the components 402-410 of the interactive session system 112. Examples of the memory 108 can include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Also as illustrated in FIG. 4, the interactive session system 112 may also include one or more physical processors, such as a physical processor 106. The physical processor 106 generally represents any type or form of hardware-implemented processing unit capable of interpreting and/or executing computer-readable instructions. In one embodiment, the physical processor 106 may access and/or modify one or more of the components 402-410 of the interactive session system 112. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally, as shown in FIG. 4, the server(s) 102 may also include one or more additional elements 114. For example, in one or more embodiments, the additional elements 114 can include additional data storage including the interactive session archive 116. In one or more embodiments, the interactive session archive 116 can include a plurality of interactive session captures generated and accessed by the session capture manager 410.

Thus, as described above and throughout the present application, the interactive session system 112 enables users to listen to and participate in a digital media session in ways not previously available. For example, during a live interactive session, the interactive session system 112 provides access to the session at multiple levels of participation. The interactive session system 112 also enables various types of interactions during the live interactive session. Furthermore, once an interactive session concludes, the interactive session system 112 further generates a capture of that interactive session that not only mirrors the original interactive session but also provides additional interactive features relative to the original interactive session.

### Example Embodiments

Example 1: A computer-implemented method for generating and providing an interactive session capture may include detecting a selection of a display option associated with an interactive session capture, generating an interactive session playback interface associated with the interactive session capture, wherein the interactive session playback interface comprises one or more speaker thumbnails and a playback timeline, detecting a selection of a playback control within the interactive session playback interface, and initiating playback of the interactive session capture while continuously updating a highlight element associated with the one or more speaker thumbnails to indicate a current active speaker of the interactive session capture.

Example 2: The computer-implemented method of Example 1, further comprising, prior to detecting the selection of the display option associated with the interactive session capture: generating the interactive session capture of an interactive session comprising one or more of an audio stream of the interactive session, a transcription of the audio stream, the one or more speaker thumbnails, one or more speaker indexes relative to the audio stream, or one or more social networking system response elements, and providing, to a user via a social networking system interface, the display option associated with the interactive session capture.

Example 3: The computer-implemented method of any of Examples 1 and 2, further comprising, during playback of the interactive session capture: detecting a selection of a closed caption option associated with the interactive session capture, and providing, within the interactive session playback interface, the transcription of the audio stream.

Example 4: The computer-implemented method of any of Examples 1-3, further comprising, during playback of the interactive session capture: detecting a selection of a comment option associated with the interactive session capture, and replacing, during continued playback of the interactive session capture, the interactive session playback interface with a comment view comprising a comment thread associated with the interactive session.

Example 5: The computer-implemented method of any of Examples 1-4, further comprising, during playback of the interactive session capture: detecting a selection of a speaker view option associated with the interactive session capture, and adding a speaker view to the interactive session playback interface comprising a listing of speakers associated with the interactive session capture.

Example 6: The computer-implemented method of any of Example 1-5, wherein the speaker view display further comprises, for each speaker in the listing of speakers, indexes indicating when the speaker spoke relative to the interactive session capture.

Example 7: The computer-implemented method of any of Examples 1-6, wherein the speaker view display further comprises social networking system controls associated with the speakers in the listing of speakers.

Example 8: The computer-implemented method of any of Examples 1-7, further comprising: detecting a text input via a comment text box within the interactive session playback interface, and adding the text input as a new comment to a comment thread of the interactive session.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
detecting a selection of a display option associated with an interactive session capture;
generating an interactive session playback interface associated with the interactive session capture, wherein the interactive session playback interface comprises one or more speaker thumbnails and a playback timeline;
detecting a selection of a playback control within the interactive session playback interface; and
initiating playback of the interactive session capture while continuously updating a highlight element associated with the one or more speaker thumbnails to indicate a current active speaker of the interactive session capture.

2. The computer-implemented method as recited in claim 1, further comprising, prior to detecting the selection of the display option associated with the interactive session capture:
generating the interactive session capture of an interactive session comprising one or more of an audio stream of the interactive session, a transcription of the audio stream, the one or more speaker thumbnails, one or more speaker indexes relative to the audio stream, or one or more social networking system response elements; and
providing, to a user via a social networking system interface, the display option associated with the interactive session capture.

3. The computer-implemented method as recited in claim 2, further comprising, during playback of the interactive session capture:
detecting a selection of a closed caption option associated with the interactive session capture; and
providing, within the interactive session playback interface, the transcription of the audio stream.

4. The computer-implemented method as recited in claim 2, further comprising, during playback of the interactive session capture:
detecting a selection of a comment option associated with the interactive session capture; and
replacing, during continued playback of the interactive session capture, the interactive session playback interface with a comment view comprising a comment thread associated with the interactive session.

5. The computer-implemented method as recited in claim 2, further comprising, during playback of the interactive session capture:
detecting a selection of a speaker view option associated with the interactive session capture; and
adding a speaker view to the interactive session playback interface comprising a listing of speakers associated with the interactive session capture.

6. The computer-implemented method as recited in claim 5, wherein the speaker view further comprises, for each speaker in the listing of speakers, indexes indicating when the speaker spoke relative to the interactive session capture.

7. The computer-implemented method as recited in claim 6, wherein the speaker view display further comprises social networking system controls associated with the speakers in the listing of speakers.

8. The computer-implemented method as recited in claim 2, further comprising:
detecting a text input via a comment text box within the interactive session playback interface; and
adding the text input as a new comment to a comment thread of the interactive session.

9. A system comprising:
at least one physical processor; and
physical memory comprising computer-executable instructions that, when executed by the physical processor, cause the at least one physical processor to perform acts comprising:
detecting a selection of a display option associated with an interactive session capture;
generating an interactive session playback interface associated with the interactive session capture, wherein the interactive session playback interface comprises one or more speaker thumbnails and a playback timeline;
detecting a selection of a playback control within the interactive session playback interface; and
initiating playback of the interactive session capture while continuously updating a highlight element associated with the one or more speaker thumbnails to indicate a current active speaker of the interactive session capture.

10. The system as recited in claim 9, further comprising computer-executable instructions that, when executed by the at least one physical processor, cause the at least one physical processor to perform acts comprising, prior to detecting the selection of the display option associated with the interactive session capture:
generating the interactive session capture of an interactive session comprising one or more of an audio stream of the interactive session, a transcription of the audio stream, the one or more speaker thumbnails, one or more speaker indexes relative to the audio stream, or one or more social networking system response elements; and
providing, to a user via a social networking system interface, the display option associated with the interactive session capture.

11. The system as recited in claim 10, further comprising computer-executable instructions that, when executed by the at least one physical processor, cause the at least one physical processor to perform acts comprising, during playback of the interactive session capture:
detecting a selection of a closed caption option associated with the interactive session capture; and
providing, within the interactive session playback interface, the transcription of the audio stream.

12. The system as recited in claim 10, further comprising computer-executable instructions that, when executed by the physical processor, cause the at least one physical processor to perform acts comprising, during playback of the interactive session capture:
detecting a selection of a comment option associated with the interactive session capture, and
replacing, during continued playback of the interactive session capture, the interactive session playback interface with a comment view comprising a comment thread associated with the interactive session.

13. The system as recited in claim 10, further comprising computer-executable instructions that, when executed by the physical processor, cause the at least one physical processor to perform acts comprising, during playback of the interactive session capture:
detecting a selection of a speaker view option associated with the interactive session capture; and
adding a speaker view to the interactive session playback interface comprising a listing of speakers associated with the interactive session capture.

14. The system as recited in claim 13, wherein the speaker view further comprises social networking system controls associated with the speakers in the listing of speakers.

15. The system as recited in claim 10, further comprising computer-executable instructions that, when executed by the physical processor, cause the at least one physical processor to perform acts comprising:
detecting a text input via a comment text box within the interactive session playback interface; and
adding the text input as a new comment to a comment thread of the interactive session.

16. A non-transitory computer-readable medium comprising one or more computer executable instructions that, when executed by at least one processor of a computing device, cause the computing device to perform acts comprising:
receiving configuration information associated with an interactive session;
determining one or more audience members for notification in association with the interactive session;
initializing the interactive session by providing the one or more audience members with access to the interactive session; and
upon conclusion of the interactive session, generating an interactive session capture associated with the interactive session.

17. The non-transitory computer-readable medium as recited in claim 16, wherein receiving configuration information associated with the interactive session comprises receiving one or more of scheduling information, speaker invitations, ephemeral option configurations, or donation configuration information.

18. The non-transitory computer-readable medium as recited in claim 16, wherein determining the one or more audience members for notification in association with the interactive session comprises:
analyzing information association with social networking system users to identify a plurality of social networking system users who satisfy a predetermined probability of being interested in the interactive session;
generating the notification comprising one or more of information detailing a date and time of the interactive session, a host(s) and/or speakers associated with the interactive session, a topic of the interactive session, an option to R.S.V.P for the interactive session, or an option to add interactive session information to a calendar; and
providing the notification to the plurality of social networking system users via one or more of newsfeeds, posts, or horizontal scroll elements.

19. The non-transitory computer-readable medium as recited in claim 16, further comprising, prior to initializing the interactive session, generating and providing a waiting room accessible to a host and speakers associated with the interactive session.

20. The non-transitory computer-readable medium as recited in claim 16, wherein providing the one or more audience members with access to the interactive session comprises converting one or more real time communication streams from computing devices associated with participants of the interactive session to RTMP streams.

21. The non-transitory computer-readable medium as recited in claim 16, wherein providing the one or more audience members with access to the interactive session comprises generating and providing an interactive session interface associated with the interactive session to the one or more audience members.

22. The non-transitory computer-readable medium as recited in claim 21, wherein generating and providing the interactive session interface further comprises continually updating a highlight element within the interactive session interface to indicate a currently active speaker within the interactive session interface.

23. The non-transitory computer-readable medium as recited in claim 21, further comprising generating and providing a back channel interface accessible to a host and one or more speakers of the interactive session.

24. The non-transitory computer-readable medium as recited in claim 16, further comprising, during the interactive session, detecting one or more social networking system interactions and comments associated with the interactive session.

25. The non-transitory computer-readable medium as recited in claim 16, further comprising, during the interactive session:
detecting a selection of an additional speaker associated with the interactive session;
generating an invitation for the additional speaker to join the interactive session; and
in response to a detected selection of the invitation, admitting the additional speaker to the interactive session.

26. The non-transitory computer-readable medium as recited in claim 16, further comprising distributing the interactive session capture to one or more of participants of the interactive session, or social networking system users who satisfy a predetermined probability of being interested in the interactive session capture.
